(19) United States
(12) Patent Application Publication
(10) Pub. No.: US 2022/0355148 A1
(43) Pub. Date: Nov. 10, 2022

(54) Phosphorous-Nitrogen Alternative to PFC Foam

(71) Applicants: Robert Valentine Kasowski, West chester, PA (US); Hahnah Seminara Kasowski, Bronxville, NY (US)

(72) Inventors: Robert Valentine Kasowski, West chester, PA (US); Hahnah Seminara Kasowski, Bronxville, NY (US)

(21) Appl. No.: 17/633,208

(22) PCT Filed: Sep. 22, 2020
(86) PCT No.: PCT/US20/52061

§ 371 Date: Feb. 6, 2022

Related U.S. Application Data
(60) Provisional application No. 62/904,570, filed on Sep. 23, 2019.
(60) Provisional application No. 62/938,903, filed on Nov. 21, 2019.
(60) Provisional application No. 62/958,618, filed on Jan. 8, 2020.
(60) Provisional application No. 62/967,526, filed on Jan. 29, 2020.
(60) Provisional application No. 63/018,433, filed on Apr. 30, 2020.

(51) Int. Cl. A62D 1/02; A62D 1/00; A62C 5/02; A62C 99/00

(52) U.S. Cl. CPC A62D 1/0071; A62D 1/0035; A62C 5/022; A62C 99/0036; A62C 99/0072

(57) ABSTRACT

An alternative to aqueous film forming foams containing fluorine for firefighting foams for flammable liquid fires is a mist of aqueous ethyleneamine polyphosphate solution or fumed silica doped ethyleneamine polyphosphate solution. The method consists of spraying a mist of such solutions into a flammable liquid fire to suppress the flames and cool the fire. The mist approach also suppresses flames of wood fires. An alternate approach is to add ethyleneamine polyphosphate or fumed silica doped ethyleneamine polyphosphate to a fluorine free foam to form a flame retarded foam that is able to smother a flammable liquid fire.

### FIELD OF INVENTION

A solution of ethyleneamine polyphosphate in the form of a mist was found to react with radicals and ions of all classes of fires to stop fires by reacting with the flame. This technology appears to be applicable to all classes of fires and as a replacement for aqueous film forming foams containing fluorine compounds. The ethyleneamine polyphosphate solution can be added to commercially available fluorine free foam concentrates to form foam that was found to extinguish flammable liquid fires.

### BACKGROUND OF INVENTION

Aqueous film forming foams (AFFF) are water-based and frequently contain hydrocarbon-based surfactant such as sodium alkyl sulfate, and fluorosurfactants, such as fluorotelomers, perfluorooctanoic acid (PFOA), or perfluorooctanesulfonic acid (PFOS). Perfluorooctanoic acid—also known as C8—is a perfluorinated carboxylic acid produced and used worldwide as an industrial surfactant in chemical processes. These fire fighting foams have been the preferred method for application to flammable liquid fires. Fluorine free foams often using surfactants such as sodium alkyl sulfate are less effective.

However, it became clear that per fluorinated compounds such as PFOS and PFOA are extremely persistent in the environment, and toxicological studies have linked the chemicals to serious negative effects on human health. Their use in the EU has been restricted since 2006 and the Stockholm Convention listed PFOS and its related substances as persistent organic pollutants that are to be phased out. A further restriction on the manufacture, use and marketing of PFOA and its related substances, under REACH, was also adopted in 2017 by the European Commission.

There is a growing body of scientific evidence that PFCs may be toxic to humans and to ecosystems. Some PFCs (PFOS and PFOA) are being phased out because of concerns about their safety. Many companies list only “proprietary fluorosurfactants mixtures” as ingredients in fire fighting foams

A per fluorinated compound (PFC) per- or polyfluoroalkyl chemical is an organofluorine compound containing carbon-fluorine bonds and C—C bonds but also other heteroatoms. PFCs, also known as perfluorinated chemicals, have properties that represent a blend of fluorocarbons (containing only C—F and C—C bonds) and the parent functionalized organic species. For example, perfluorooctanoic acid functions as a carboxylic acid but with strongly altered surfactant and hydrophobic characteristics. Fluorosurfactants are ubiquitously used in Teflon, water resistant textiles and fire-fighting foam.

The presence of perfluorinated compounds (PFCs) in source waters and drinking water is of growing concern to water professionals. This group of organic compounds, used for industrial and consumer applications such as nonstick coatings and firefighting foams, has potential health implications for humans and wildlife. PFCs are extremely persistent. Researchers are finding serious health concerns about PFCs, including increased risk of cancer. PFOA is a likely human carcinogen; it causes liver, pancreatic, testicular, and mammary gland tumors in laboratory animals. PFOS's half-life is estimated at more than 8 years.

An alternative halogen free environmentally friendly fire fighting technology for application to flammable liquid fires is of need. It is found that aqueous solutions of ethyleneamine polyphosphate in the form of a mist can extinguish flammable liquid fires. These solutions can added to foam concentrates to form a foam that is effective in extinguishing flammable liquid fires as well as other classes of fires. Currently, different fire extinguishers are recommended for different types of fires. Fire extinguishers containing aqueous solutions of ethyleneamine polyphosphate can be used on any type of fire and would eliminate the confusion as which extinguisher to use. This technology offers the capability to be mobile to go off road to a fire utilizing a pressure washer and a pressurized water tank with a bladder mounted on inexpensive all terrain vehicles.

### SUMMARY

Aqueous fire extinguishing solutions consisting of one or more aqueous solutions selected from the group consisting of ethyleneamine polyphosphate solution (EAPPA); doped ethyleneamine polyphosphate solution (EAPPA-D); condensed ethyleneamine polyphosphate solution (EAPPA-C); doped condensed ethyleneamine polyphosphate solution (EAPPA-CD) a) in the form of a mist or b) in the form of a foam or a mist when the aqueous solution additionally contains two or more compounds chosen from the group consisting of surfactant, thickening agent, water, and organic solvent can be applied as a mist or as a foam to provide an alternative to fluorinated foams for extinguishing any fire. A method to create the mist of claim 1 consists of forcing the EAPPA or EAPPA-D solution through a mist spray nozzle under pressure. The foam is formed by forcing the solution through an aeration foam spray nozzle or a foam cannon. It is possible to extinguish a gasoline fire with a mist of the foam solution with a mist nozzle. Then change the mist nozzle to a foam nozzle and spray foam over the gasoline to protect from re-ignition. This technology is effective for all classes of fires as the chain reaction sustaining the fire is interrupted by a mist or a foam blanket can be formed over the fire. The mist should consist of droplets with a volume median diameter (VIVID) less than 1500 micron, or less than 600 microns preferred, or less than 400 microns more preferred, or less than 200 microns even more preferred, or less than 75 microns most preferred. EAPPA or EAPPA-D made by any method is part of this invention. The preferred dopant is hydrophillic fumed silica. The application PCT/US19/034077 does not disclose the following: 1) use of EAPPA or EAPPA-D for firefighting especially spraying a mist directly into flames for all types of fires, 2) formation of foam with EAPPA or EAPPA-D, and 3) does not disclose that addition of hydrophillic fumed silica to EAPPA or EAPPS-D to improve fire suppression.

### DETAILED DESCRIPTION

Ethyleneamine polyphosphate (EAPPA) is formed by direct reaction of ethyleneamine (EA) and commercial polyphosphoric acid (PPA) near the theoretical acid base ratio with the reaction performed without water or other solvent. This form of EAPPA can be made by reacting any grade of PPA with EA. The synthesis without a dopant is detailed in U.S. Pat. No. 10,501,602. Synthesis with dopants such as fumed silica is covered in PCT/19/034077. It was not disclosed in either reference that such aqueous compositions containing hydrophillic fumed silica promote adhesion and suppress dripping from surfaces which is most helpful in the application of these solutions to extinguishing fires. The synthesis of flame-retardants using polyphosphoric acid is disclosed in U.S. Pat. Nos. 7,138,443, 8,212,073; WO 2011/049615 (PCT/US12/000247), PCT/US2003/017268, and U.S. Pat. No. 8,703,853. Fluorine free foam is disclosed in U.S. Pat. No. 7,569,155 and is prior art. The entire disclosure is incorporated herein by reference. FS can be added to PPA before synthesis of EAPPA. FS can be added directly to aqueous solutions after synthesis. It is preferred to make EAPPA and EAPPA-FS and then dilute with water to desired concentration. It is also possible but less preferred to dilute the polyphosphoric acid with water and then add ethyleneamine to make the desired product. The most preferred EAPPA and EAPPA-FS is made with PPA and the following ethyleneamines: ethylenediamine (EDA), diethylenetriamine (DETA), piperazine (PIP), triethylenetetramine (TETA), tetraethylenepentamine (TEPA), and pentaethylenehexamine (PEHA).

Ethyleneamines are defined here as ethylene diamine and polymeric forms of ethylene diamine including piperazine and its analogues. A thorough review of ethyleneamines can be found in the Encyclopedia of Chemical Technology, Vol 8, pgs. 74-108. Ethyleneamines encompass a wide range of multifunctional, multi reactive compounds. The molecular structure can be linear, branched, cyclic, or combinations of these. Examples of commercial ethyleneamines are ethylenediamine (EDA), diethylenetriamine (DETA), piperazine (PIP), triethylenetetramine (TETA), tetraethylenepentamine (TEPA), and pentaethylenehexamine (PEHA). Other ethyleneamine compounds which are part of the general term ethyleneamine (EA) which may be applicable are, aminoethylenepiperazine (EAP), 1,2-propylenediamine, 1,3-diaminopropane, iminobispropylamine, N-(2-aminoethyl)-1,3-propylenediamine, N, N′-bis-(3-aminopropyl)-ethylenediamine, dimethyl aminopropylamine, and triethylenediamine. Ethyleneamine polyphosphate can be formed with any of these ethyleneamines.

Polyphosphoric acid (PPA) is an oligomer of H3PO4. High purity PPA is produced either from the dehydration of H3PO4 at high temperatures or by heating P2O5 dispersed in H3PO4. The equilibrium for these reactions produces different chains lengths and distributions. The dehydration method tends to produce short chains, whereas the dispersion method usually produces chains with more than 10 repeat units, which are more preferable in making the compositions of this invention. Many different temperatures are used in the reaction of P2O5 and 85% concentration phosphoric acid in making PPA.

PPA is available in various grades, the naming of which can be confusing as the percentage can exceed 100%. One hundred percent phosphoric acid contains 72.4% P2O5 as calculated from the formula weight ratio P205/H3PO4. Similarly, Pyrophosphoric acid (H4P207) contains 79.8% P2O5 as calculated from the ratio P205/H4P207. The ratio of these P2O5 contents provides a relative phosphoric acid content, which for pyrophosphoric acid is 79.8%/72.4%=110%. Due to high viscosity, PPA is difficult to pour and stir at room temperature, but is much easier to work with at temperatures above 60° C.

The production of PPA provides a distribution of chain lengths, where the number of repeat units in the PPA chain n, varies from one chain to the next. The 105% PA grade from Innophos Corp. contains for the most part short monomeric and dimeric segments, ortho (54%), pyrophosphoric (41%) and 5% triphosphoric and pours easily and would not be expected to provide a route to high molecular weight EAPPA. In the higher 115% grade, little monomer is left as most of the chain lengths are 2-14 units long. This increase in chain length leads to chain entanglements and explains the increased viscosity of the higher grades. Only the 117% grade (3% Ortho, 9% pyro, 10% tri, 11% tetra, 67% higher acids), 115% grade (5% ortho, 16% pyro, 17% tri, 16% tetra, 46% higher) and 105% grade are used throughout the examples. They are from Innophos, Trenton, N.J. All grades of PPA are claimed regardless of how formed.

EAPPA has been made directly by the reaction of ethyleneamine with polyphosphoric acid or condensed PPAC (condensed polyphosphoric acid) and with the ratio of PPA or PPAC to ethyleneamine chosen so that the pH of a 10% aqueous solution by weight of the resulting composition is at least 2.7. It is preferred that the pH is at least 3.5. More preferred is 4.2. Most preferred is pH greater than or equal to 5.0.

Condensation is defined as subjecting polyphosphoric acid to vacuum at a temperature exceeding 200° C. for at least 15 minutes. EAPPA made with condensed PPA will be referred to as EAPPA-C. A doped ethyleneamine polyphosphate (EAPPA-D) has been formed comprising a reaction of ethyleneamine with doped polyphosphoric acid formed by reacting polyphosphoric acid with one or more dopants chosen from the group consisting of polyalpha olefin, hydrophilic fumed metal oxides (FMO), nanocomposites, clay, amorphous silica, epoxy, hydrophilic fumed silica, and organo silane, and the dopants have the property of being compatible in polyphosphoric acid or condensed polyphosphoric acid, and with the ratio of doped polyphosphoric acid to ethyleneamine chosen so that the pH of a 10% aqueous solution by weight of the resulting composition is at least 2.7. If condensed polyphosphoric acid containing a dopant is used then the new composition is doped condensed ethyleneamine polyphosphate EAPPA-CD. The aqueous doped EAPPA-CD is also a suitable flame retardant to stop flames directly as higher molecular weight and higher specific gravity which results in less drift when sprayed as a mist.

Hydrophilic fumed metal oxides can be made from other elements such as titanium oxide, aluminum oxide, and iron oxide. Other metal oxides could become available. Hydrophilic fumed silica is preferred. Nanocomposites are multiphase solids of 1, 2, or 3 dimensions with at least one dimension being less than 100 nm in size. Exfoliated Organo clays are considered prime examples as consisting one dimension sheets of clay, with only one dimension less than 100 nm thick. Preferred dopant D is hydrophilic fumed silica (FS) and these compounds designated as EAPPA-FS and EAPPA-CFS. It is also possible to make EAPPA-FS and EAPPA-CFS by adding FS to aqueous solutions of EAPPA and EAPPA-C, although this method is not preferred. For all examples in this specification, the ethyleneamine shall be DETA, diethylenetriamine.

A gel is a semi-solid that can have properties ranging from soft and weak to hard and tough. Gels are defined as a substantially dilute cross-linked system, which exhibits no flow when in the steady-state. By weight, gels are mostly liquid, yet they behave like solids due to a three-dimensional cross-linked network within the liquid. It is the cross linking within the fluid that gives a gel its structure (hardness) and contributes to the adhesive stick (tack). In this way, gels are a dispersion of molecules of a liquid within a solid medium. In PCT/19/034077, it was disclosed that the composition DETAPPA-CFS (condensed diethylenetriamine polyphosphate doped with hydrophilic fumed silica) formed a gel when dissolved in water at 1:1 ratio by weight. In less than three weeks a transparent gel was formed with a dark red color. A gel does not form when DETAPPA-C is dissolved in water at same ratio thus showing FS is essential. These results indicate the role of hydrophilic fumed silica in altering the properties of EAPPA consistent with inherent reaction. There is no apparent way to separate the hydrophilic fumed silica and obtain EAPPA-C. Fumed silica has made the components of DETAPPA-CFS react with each other or for our purposes become sticky so that such aqueous solutions attach easily with any material or fuel that it touches suppresses dripping off the surface. The usefulness of the property that aqueous solutions of EAPPA and EAPPA-C containing hydrophillic fumed silica are much stickier and more effective in extinguishing flames or containing fires was not appreciated in PCT/19/034077. Fumed silica also is a thickening agent that increases viscosity which is also useful in fire extinguishment.

EAPPA, EAPPA-D, EAPPA-C, EAPPA-CD, and these compositions additionally containing fumed silica added directly to the solutions made by any method are claimed as long as an aqueous solution in the form of a mist or foam can be formed. More complex synthesis as well as more efficient is likely in the future and capable of being made into solutions in the form of a mist or a foam. For example, an aqueous solution of PPA and DETA could be sprayed into a chamber where the reaction could be contained and allowed to exit continuously. Any unevenness would be overcome in the final tank for spraying. A variety of pH values are acceptable.

Intumescense of a coating, as used in the context of this specification, is the swelling up when heated or subjected to flames, thus protecting the material underneath in the event of a fire. Fire resistant paints typically contain ammonium polyphosphate, pentaerythritol, dipentaerythritol, and melamine and a binder such as vinyl acetate copolymers. When subjected to heat or flame, the coating becomes a light char or micro porous carbonaceous foam due to chemical reaction of three main components. The identifying unique characteristic of ethyleneamine polyphosphates is that these compounds intumescence from heat or flames, with no need for melamine or pentaerythritol. This property is referred to as self intumescence.

Relevant background is that when lightning strikes a tree it can explode when the moisture inside is converted to steam in a millisecond. Exploding trees also occur during forest fire and the sounds can be heard. One also hears the cackling of a wood stove when green wood is being burned. The pressure of the steam and sap makes the green wood burst. In a forest fire, this happens especially with trees whose trunks are already dying or rotting. Droplets of the fire extinguishing solutions are expected to explode in the very hot flame plasma as well as react with ions and radicals composing a plasma and deprive the fire of energy to continue.

Mist applies to a condition where water is held in suspension in fine particles in the air, floating or slowly falling in minute drops. Vapors are composed of single, gas-phase molecules whereas mist droplets are liquid-phase and contain thousands or millions of molecules. Common examples of mist are spray cans, clouds and fog where mist droplets are very small. Their mean diameter is typically only 10-15 micron (1 micron=1/1000 mm) but in any one cloud the individual drops range greatly in size from 1 to 100 micron dia. Haze, mist, fog, and smog denote an atmospheric condition which deprives the air near the earth of its transparency. Steam is the vapor into which water is converted when heated, forming a white mist of minute water droplets in the air.

Mist is defined here as a cloud of tiny droplets of fire extinguishing solution. Mist is not a very distinct term except that it is formed of tiny droplets and the visibility is reduced depending on droplet size and density. Droplet sizes are measured in microns. A micron is 1/1000 millimeter (micrometer), or about 1/25,000 of an inch. For perspective, a human hair is about 100 microns in diameter. Spray droplets smaller than 150 microns tend to be prone to drift. High pressure such as 4000 PSI will overcome mild drift problems.

It turns out that it is necessary to form a mist for EAPPA solutions to be effective for direct application to the flames of any type of fire. The dimension of the droplets within the mist is also of critical importance. Volume Median Diameter (VIVID) refers to the midpoint droplet size (median), where half of the volume of spray is in droplets smaller, and half of the volume is in droplets larger than the median. If the droplets are large, the spray is far less effective. The efficiency of extinguishing a fire increases rapidly as the droplet size is reduced.

In agriculture, there exists equipment with which to spray aqueous solutions in the form of a mist. The droplet size within a mist is defined by VIVID. Extremely fine has the code XF and droplet size less than 60 micron. Very fine is VF and droplet size 60-145 micron. Fine is F and droplet size 145-225 microns. Medium is M and size 226-325 microns. Coarse is C and droplet size 326-400 microns. Very coarse is VC and droplet size 401-500 microns. EC is extremely coarse and droplet size 501-650. Ultra coarse is UC and droplet size greater than 650 micron. These are the adopted ranges of particle size in agriculture spraying which is done at 40-100 PSI spraying. Spray tip nozzles are designed to enable a wide variety of droplet sizes. The droplet size is defined for spraying water.

For our purposes, a droplet size of 1500 microns and less is claimed for formation of a mist of fire extinguishing liquid when projected thru a nozzle with a tiny hole by pressure. The nozzle can cause the mist to have a variety of shapes and droplet sizes. We exclude the use of a continuous stream of liquid from a large hose or from dropping of liquid from an aircraft. In agriculture, drift, plant coverage, penetration of plant foliage and delivery equipment are carefully considered in choosing the right nozzle to obtain the best droplet size for chemicals applied to soil and plants.

The value of spraying a mist was first realized when DETAPPA solution was sprayed with a paint sprayer. Airless spray gun widely used in paint spraying form a fan shaped mist with droplet 70 to 130 microns (3-5 mils) at a pressure of 2000-3000 PSI. Mist in form of a fan gives even coverage or overlap.

For a small brush fire, a fine mist spray could be chosen as the fire can be approached within feet. Drift from wind and penetration of the brush is not an issue. For a canopy fire, it may be necessary to apply droplets more akin to a light drizzle from aircraft at a distance above the canopy so that drift from wind does not prevent hitting the target. There may be situations where is desirable to penetrate the canopy for application to fuel on the ground which requires a coarse spray. Forest fires are known to get so hot the water within the wood explodes the wood apart. Coarse droplets dropped into such a flame would be expected to break into fine mist droplets and make EAPPA solutions more effective. So a range of mist particle size from fine to ultra course may be applicable depending on fire size and wind conditions.

For a large tank fuel fire, the heat could be extreme thus limiting approach. Coarse droplet size might be the best approach as the large droplets should basically explode when the droplets react with the flame plasma and can be directed from a safer distance. Coarse droplets are still under the very general term mist. Course particle size could be used on the fuel and materials in front of a fire and around a fire. The ideal is to use a fine mist droplet size as most efficient, but practical considerations may force the larger droplet size to be used. It is important to spray a pattern that covers an area and not a single stream. For large tank fires a robotic arm could be used to apply a boon configuration of mist nozzles.

The mist here is composed of aqueous solutions of EAPPA, EAPPA-D, EAPPA-C, EAPPA-CD, and these compositions additionally containing fumed silica (FS) added directly to solutions. A less desirable mist is formed from aqueous suctions of ammonium phosphate, ethyleneamine sulfate, or ammonium polyphosphate which may additionally contain pentaerythritol or dipentaerythritol. Ethyleneamine sulfates can be made by reacting an ethyleneamine with sulfuric acid following the closed reactor synthesis used to make EAPPA, as much heat is released.

Aqueous solutions of EAPPA, EAPPA-C, EAPPA-D, and EAPPA-CD made with DETA and FS as the dopant will be referred to as PNS. All examples of PNS were made using PPA grade 115% reacted with DETA. The pure product was diluted with water to a 40%-50% solution by weight for nearly all mist examples. It is also possible to dilute PPA with water and then add EA to form an aqueous form of EAPPA or EAPPA-D although this method is not preferred. The water breaks down the molecular weight especially with temperature so that the solution is a polymer of lower molecular weight and no free water. The solutions reported in the examples are made by diluting PNS made with PPA 115% and DETA. Such examples could be made directly by using PPA comparable to that grade of PPA. We use this high molecular weight method as solids minimize cost, storage, and transportation problems. The solid is converted to PNS solution when needed.

Compositions will be discussed and disclosed usually by %. It is always % by weight of composition and never by volume unless specifically indicated.

Ammonium polyphosphate and ammonium phosphate aqueous solutions in the form of a mist are less preferred than PNS because they do not intumesce when exposed to a flame or intense heat. The intumescence of ammonium polyphosphate could be improved with addition of melamine, pentaerythritol, or dipentaerythritol. Ethyleneamine sulfates are not preferred due to toxicity issues that are not present with EAPPA.

Synthesis of ethylenediammonium sulfate (EDS) at laboratory scale has been published. The reaction of ethylenediamine with sulfuric acid is highly exothermic so the reaction must be carried out slowly with continuous ice cooling. An alternative procedure for application as a fire retardant is to first choose the desired concentration of aqueous solution. Add sulfuric acid diluted with water and then add an ethyleneamine with EDA or DETA being preferred. The amount of water is chosen so that the final product has the desired aqueous concentration. The reaction has to be done in a sealed reactor as the reaction releases a lot of heat. The aqueous solution can be sprayed as a fine mist and used as a fire extinguisher. The aqueous solution can be added to a solution EAPPA to serve as a surfactant. Ethylenediamine sulfate is labeled as acute toxic and thereby not preferred even though it could be quite effective.

A radical is a chemical species that contains an unpaired electron. In general, radicals are reactive and form new bonds again very quickly. A radical may by electrically neutral, positively charged (radical cation) or negatively charged (radical anion). An ion carries a charge that means that the number of electrons and protons do not match. Electrons have a negative charge and protons have a positive charge. Ions will seek the opposite charge to become neutral.

At a certain point in the combustion reaction, called the ignition point, flames are produced. The flame is the visible portion of the fire. If hot enough, the gases may become ionized to produce plasma. A flame (from Latin flamma) is the visible, gaseous part of a fire. It is caused by a highly exothermic reaction taking place in a thin zone. Very hot flames are hot enough to have ionized gaseous components of sufficient density to be considered plasma. The high temperature of the flame causes the vaporized fuel molecules to decompose, forming various incomplete combustion products and free radicals, and these products then react with each other. Sufficient energy in the flame will excite the electrons in some of the transient reaction intermediates such as the methylidyne radical (CH) and diatomic carbon (C₂), which results in the emission of visible light as these substances release their excess energy. As the combustion temperature of a flame increases (if the flame contains small particles of unburnt carbon or other material), so does the average energy of the electromagnetic radiation given off by the flame. The chemical kinetics occurring in the flame are very complex and typically involve a large number of chemical reactions and intermediate species, most of them radicals. A fire is an example of a chemical chain reaction, A burning candle or other fire is an example of a chemical chain reaction.

The PNS mist are also undergoing these processes of forming ions and radicals and becoming part of the reaction. FNS is applicable to all classes: class A—fires involving solid materials such as wood, paper or textiles; class B—fires involving flammable liquids such as petrol, diesel or oils; class C—fires involving gases; class D—fires involving metals; class E—fires involving live electrical apparatus; class K—fires involving vegetable oils, animal oils, or fats in cooking appliances. It could be argued that PNS is not applicable to electrical fires because PNS solutions do not insulate even though very little would be used and unlikely to present electrical hazard.

The fire point of a fuel is the lowest temperature at which the vapor of that fuel will continue to burn for at least 5 seconds after ignition by an open flame of standard dimension. At the flash point, a lower temperature, a substance will ignite briefly, but vapor might not be produced at a rate to sustain the fire. The flash point is an important concept in fire investigation and fire protection because it is the lowest temperature at which a risk of fire exists with a given liquid. The flash point for gasoline is about −45° F., for diesel it is 126-205° F., for heptane it is 25° F. Thus, gasoline fires are much more dangerous than diesel fires.

Vapor pressure is the pressure caused by the evaporation of liquids. Three common factors that influence vapor press are surface area, intermolecular forces and temperature. The vapor pressure of a molecule differs at different temperatures. The most common measure of vapor pressure for gasoline is Reid vapor pressure (RVP). This is the pressure, in psi (pounds per square inch) or kPa (kiloPascals), necessary to keep a liquid from vaporizing when at 100° F. (37.8° C.). The RVP for gasoline is 7.8 to 16 PSI, a lot of vapors are being formed. Diesel has RVP is far lower at 0.03 to 0.1 PSI, very few vapors. Heptane has a RVP of about 1 PSI, nearly the same as water, intermediate vapors. Jet fuel RVP is about 0.21 PSI, very few vapors. Thus, gasoline is easy to ignite even at very low temperatures making it very easy to ignite as compared to diesel or jet fuel. From the flash point and Reid vapor pressure, it is very significant that EAPPA technology is able to extinguish gasoline fires.

In U.S. Pat. No. 10,501,602, spraying has been mentioned as the method to apply EAPPA solutions onto fires. The method consisted of spraying the fuel or wood in front of the class A fire to deprive the fire of fuel. There is no mention of spraying directly the flames of class A fire or spraying a mist with special technology. The method here consists of directly attacking by spraying a fine mist into the flames. Common fire extinguishers contain a stream of fire suppression solution. Flammable liquids such as gasoline are particularly difficult to suppress due to re-ignition. A stream covers too small of an area.

A tray of diesel fuel requires a few minutes with a propane torch to ignite whereas gasoline is immediately ignited as the torch approaches. Canola cooking oil in the same tray did not ignite even after five minutes with a propane torch. Fire extinguisher testing is often done with diesel fuel or heptanes and listed for class B fuels even though it is unlikely to extinguish a gasoline fire. The most common extinguisher is A10BC. This extinguisher should extinguish any 10 sq. ft. flammable liquid fire. A gasoline fire is too hot to approach and spray at the bottom of the fire unless wearing protective gear that home owners would be unlikely have access to in fire emergency. It will be shown that spraying a mist of PNS solution douses the flames rapidly so that the tester can go directly to the fire and extinguish it without protective, heat shielding gear.

A fire extinguisher is a portable device that discharges a jet of water, foam, gas, or other material to extinguish a fire. More specifically, a fire extinguisher consists of a hand-held cylindrical pressure vessel containing an agent which can be discharged to extinguish a fire. Fire extinguishers manufactured with non-cylindrical pressure vessels also exist but are less common. There are two main types of fire extinguishers: stored-pressure and cartridge-operated. In stored pressure units, the expellant is stored in the same chamber as the firefighting agent itself. Depending on the agent used, different propellants are used. With dry chemical extinguishers, nitrogen is typically used; water and foam extinguishers typically use air. Stored pressure fire extinguishers operating at 100 PSI are the most common type. Cartridge-operated extinguishers contain the expellant gas in a separate cartridge that is punctured prior to discharge, exposing the propellant to the extinguishing agent. A carbon dioxide fire extinguisher operates at pressures greater than 700 PSI which is likely adequate to spray PNS for all class fires. Some of these fire extinguishers can operate above 2000 PSI. Spraying is a very general term that includes spraying water with a common garden hose where there is no mist and the spray is continuous.

Airless spray atomizes or breaks up fluid into small droplets without the use of compressed air. In an airless system, fluid is pumped under high pressure through a spray tip. The tip size and pressure is what determines the material flow rate. The tip also creates the fan pattern. In airless spray, the fast moving high-pressure liquid stream provides the energy necessary to overcome the fluid's viscosity (resistance to flow) and surface tension (a force that bonds the surface of a liquid together) to form a fine spray. In the depiction of spray from a gun, high pressure forces fluid through a small nozzle (spray tip). The fluid emerges as a solid stream (sheet) at a high speed. When the solid stream hits the air, it becomes disrupted. This disruption breaks the fluid into fragments initially, then ultimately very small droplets that form the spray pattern.

In contrast, air spray systems inject compressed air into the fluid stream of paint to achieve atomization into tiny droplets.

Single-fluid or hydraulic spray nozzles utilize the kinetic energy of the liquid to break it up into droplets. This most widely used type of spray nozzle is more energy efficient at producing surface area than most other types. As the fluid pressure increases, the flow through the nozzle increases, and the droplet size decreases. Many configurations of single fluid nozzles are used depending on the spray characteristics desired.

Nozzles break the liquid into droplets, form the spray pattern, and propel the drops in the proper direction. Most common nozzles are flat, flood, air induction, raindrop, hollow-cone, full-cone, and others. Flat fan nozzles are widely used for broadcast spraying of herbicides in a fan shape and are used in this specification. There are subtypes such as standard flat fan as used here, even flat fan, low pressure flat fan, extended range flat fan, twin orifice, and many more.

There are dozens of nozzles and hundreds of sizes and materials of construction. The simplest single fluid nozzle is a plain orifice nozzle. This nozzle often produces little if any atomization, but directs the stream of liquid. If the pressure drop is high, at least 25 bars (2,500 kPa, 363 PSI), the material is often finely atomized, as in a diesel injector. At lower pressures, this type of nozzle is often used for tank cleaning, either as a fixed position compound spray nozzle or as a rotary nozzle. Higher P decreases droplet size. Smaller nozzle also results in smaller droplets. Our technology depends on fine droplet size mist. For spraying water, a fourfold increase in pressure, results in double flow rate. The most common spray nozzles are flat fan, hollow cone, full cone, and streaming nozzles.

For flat spray nozzles, the shaped orifice uses a semispherical shaped inlet and a V notched outlet to cause the flow to spread out on the axis of the V notch. This nozzle is called a flat tip spray nozzle with a fan shaped spray. A flat fan spray pattern is useful for many spray applications, such as spray painting and agriculture spraying. This type of technology has not been used in fire fighting. Very tiny droplets really slow down when they leave the nozzle. Small droplets dry quickly loosing the water contribution. As the density of the liquid being sprayed increases, the spray angle decreases which is significant for spraying fire fighting solutions.

Most companies identify their flat-fan nozzles with a four or five digit number. The first numbers are the spray angle and the other numbers signify the discharge rate of water at rated pressure. For example, an 8005 has an 80 degree spray angle and will apply 0.5 gallons per minute (GPM) at rated pressure of 40 psi. An 8003 is used in this specification, which has 80 angle and 0.3 GPM at 40 psi for water. However the spray rates are different at different pressures and different liquids. A 8003 flat spray tip was hooked to the hose from a fire extinguisher tank containing water at 100 PSI. The spray rate was 0.51 GPM for the 8003 and 0.97 GPM for the 8006 at a 100 PSI significantly larger that at 40 PSI manufacturers data. For a pressure washer operating at 4000 PSI, the use of the both the 8003 and 8006 spray tips gives a spray rate for water of 2.3 GPM. The spray rate is the same if a Y connection is used to have two spray tips. It was unexpected that the flat tip spray rate for 4000 PSI pressure washer gave the same rate for spraying water.

For spraying a polymeric, 50% concentration solution DETAPPA-FS with the 8003 nozzle with the pressure washer 4000 PSI, the amount of liquid sprayed was about 3.1 GPM. So the fumed silica seems to lower the viscosity of DETAPPA-FS to a value lower than spraying water.

Just as there are many types of nozzles, there are many types of sprayers. One of the most common forms of pesticide application, especially in conventional agriculture, is the use of mechanical sprayers. Hydraulic sprayers consists of a tank, a pump, a lance (for single nozzles) or boom, and a nozzle (or multiple nozzles). Sprayers convert a pesticide formulation, often containing a mixture of water (or another liquid chemical carrier, such as fertilizer) and chemical, into droplets, which can be large rain-type drops or tiny almost-invisible particles. This conversion is accomplished by forcing the spray mixture through a spray nozzle under pressure. The size of droplets can be altered through the use of different nozzle sizes, or by altering the pressure under which it is forced, or a combination of both. Large droplets have the advantage of being less susceptible to spray drift, but require more water per unit of land covered. Due to static electricity, small droplets are able to maximize contact with a target organism, but very still wind conditions are required.

One way to distinguish between a hydraulic sprayer and low-volume sprayer is by droplet size. Hydraulic sprayers produce a spray with most droplets in the 200-400 micron diameter range (thickness of the human hair is about 100 microns). Low-volume sprayers develop a mist (50-100 microns) or fog (0.05-50 microns). Small droplets from a mist or applicator can result in more uniform coverage and greater likelihood of contact with the insect or disease. In contrast to the hydraulic sprayer, spray material is usually applied to “glisten” as it is difficult to see the individual droplets on the leaf. Fog is a subclass of mist. One possibility for increasing application precision and efficiency is using an optimum droplet size throughout an application. Pulse-width modulation (PWM) sprayers (Capstan PinPoint®, Case IH AIM Command®, John Deere ExactApply®, TeeJet Dynajet®, and Raven Hawkeye®) can variably control flow by pulsing electronically actuated solenoid valves. A PWM sprayer can maintain a flow rate across a wide range of sprayer speeds, and minimize overlap with individual nozzle control and flow turn compensation. Moreover, pulsing of the solenoid valves has a minimal impact on droplet size when using non-air inclusion nozzles, resulting in the ability to maintain an optimum droplet size across an entire field.

Even small changes in droplet diameter make big differences in droplet weight. An increase in droplet diameter from 150 microns to about 190 microns doubles the droplet weight. An increase in droplet diameter from 150 microns to about 240 microns increases the weight 4 times. Doubling the diameter to 300 microns increases its weight, and also its volume, by 8 times. Heavier droplets fall more quickly and are less affected by air movement.

An airless sprayer works by pumping paint at a very high pressure, up to 3,000 psi, through a hose and out a tiny hole in the spray gun tip. The tip is designed to break up the paint evenly into a fan-shaped spray pattern of tiny droplets. Such an apparatus has been successfully used for one sq. ft. gasoline fires successfully. The volume is too low for 8 sq. ft. and larger gasoline fires.

In an HVLP (which stands for “high volume, low pressure”), air pumped from an air compressor or turbine atomizes paint. In an airless sprayer, a piston pressurizes the material, which sprays out of an orifice smaller than that found on an HVLP nozzle. But airless units are also more powerful. This process occurs when paint is applied to an object through the use of an air-pressurized spray gun. The air gun has a nozzle, paint basin, and air compressor. When the trigger is pressed the paint mixes with the compressed air stream and is released in a fine spray.

In airless spray, the fast moving high-pressure liquid stream provides the energy necessary to overcome the fluid's viscosity (resistance to flow) and surface tension (a force that bonds the surface of a liquid together) to form a fine spray. In the depiction of spray from a gun, high pressure forces fluid through a small nozzle (spray tip). The fluid emerges as a solid stream (sheet) at a high speed. When the solid stream hits the air, it becomes disrupted. This disruption breaks the fluid into fragments initially, then ultimately very small droplets that form the spray pattern. EAPPA solutions have much higher surface tension than water especially for high molecular weight forms.

The fluid pressure is provided by an airless pump, which allows much heavier materials to be sprayed than is possible with an air spray gun. Compressed air is introduced into the spray via an air nozzle (sometimes called air cap) similar to a standard conventional spray gun. The addition of compressed air improves the fineness of atomization. Additionally unlike a pure airless spray gun, an AA gun has some control over fan spray to round spray. Some electric airless sprayers (Wagner and Graco) are fitted with a compressor to allow the use of an air-assisted airless gun in situations where portability is important.

Airless spray guns operate connected to a high pressure pump commonly found using 300 to 7,500 pounds per square inch (2,100-51,700 kPa) pressure to atomize the coating, using different tip sizes to achieve desired atomization and spray pattern size. This type of system is used by contract painters to paint heavy duty industrial, chemical and marine coatings and linings.

Hydraulic sprayers consists of a tank, a pump, a lance (for single nozzles) or boom, and a nozzle (or multiple nozzles). Sprayers convert a pesticide formulation, often containing a mixture of water (or another liquid chemical carrier, such as fertilizer) and chemical, into droplets, which can be large rain-type drops or tiny almost-invisible particles. This conversion is accomplished by forcing the spray mixture through a spray nozzle under pressure. The size of droplets can be altered through the use of different nozzle sizes, or by altering the pressure under which it is forced, or a combination of both.

Air Blast sprayers, also known as air-assisted or mist sprayers, are often used for tall crops, such as tree fruit, where boom sprayers and aerial application would be ineffective. These types of sprayers can only be used where overspray—spray drift—is less of a concern, either through the choice of chemical which does not have undesirable effects on other desirable organisms, or by adequate buffer distance. These can be used for insects, weeds, and other pests to crops, humans, and animals. Air blast sprayers inject liquid into a fast-moving stream of air, breaking down large droplets into smaller particles by introducing a small amount of liquid into a fast-moving stream of air.

Sprayers producing the smallest droplet size are called foggers. Foggers produce particles of very small size, but use a different method. Whereas mist sprayers create a high-speed stream of air which can travel significant distances, foggers use a piston or bellows to create a stagnant area of pesticide that is often used for enclosed areas, such as houses and animal shelters.

Pesticides are conventionally applied using hydraulic atomizers, either on hand-held sprayers or tractor booms, where formulations are mixed into high volumes of water.

Polar liquids are liquids that contain polar molecules. For molecules to be polar, it has to experience dipole moments within itself. Dipole moment is caused by unequal electronegativity between atoms in a covalent bond. For example, oxygen is very electronegative, meaning that it is craving for electrons very badly. When oxygen and hydrogen are covalently bond together, like a water molecule, oxygen will draw electrons from hydrogen towards itself. This results a region of higher density of electron clouds around oxygen and less dense electron clouds around hydrogen. This unequal distribution of electron cloud causes a dipole moment within the molecule. So water molecule by itself is actually polar. (However, water is not a good polar solvent. It's because when water molecules are together, they are hydrogen bonding each other, reducing the polar effect.)

Therefore, to identify whether a solvent is polar or not, one can first look at the molecule and identify whether it has dipole moment. In other words, whether the atoms in the molecule are covalently bonded and have an unequal distribution of electron clouds. Examples of polar liquids include methanol, ethanol and ammonia. Non-polar liquid includes hydrocarbon oils, toluene and chloroform.

Gasoline is not soluble in water. Gasoline is a complex mixture of non-polar compounds such as long chained hydrocarbons etc. Water is a polar molecule. The general solubility rule is that “like dissolves like”, meaning polar dissolves polar and non-polar dissolves non-polar.

Pressure washing is the use of high-pressure water spray to remove loose paint, mold, grime, dust, mud, chewing gum and dirt from surfaces and objects such as buildings, vehicles and concrete surfaces. A power washer uses a high-pressure stream of very hot water to blast away dirt and materials from outdoor surfaces. The volume of a mechanical pressure washer is expressed in gallons or liters per minute, often designed into the pump and not variable. The pressure, expressed in pounds per square inch, pascals, or bar, is designed into the pump but can be varied by adjusting the unloader valve. Machines that produce pressures from 750 to 30,000 psi (5 to 200 MPa) or more are available. Ordinarily, the pressure washer takes in ordinary water from a garden hose, the pump accelerates the water to high pressure, and then squirts it from a hose at speed through a trigger gun that has a small outlet orifice compared to hose diameter. Usually, water comes out at 1550-3000 PSI. A pressure washer is primarily used for cleaning not for agriculture spray or firefighting.

It has been found that the preferred method to create very fine PNS mist is with a modified pressure washer (1500 PSI to 4000 PSI) and fine mist nozzle. Instead of a garden hose, fire extinguisher tank at 100 PSI or a 20 gallon tank with a bladder containing pressurized PNS solution at 50 PSI pressure is attached to the pressure washer as the source. The conventional spray tip is replaced with a spray tip from agricultural spraying for creating a 80° to 100° fan shape mist. In agriculture industry, these tips are according to how much water in GPM is sprayed at a 40 PSI. Spray tips that spray at 80° angle and at a rate of 0.1 (8001) to 0.3 (8003) gallon per minute for water at a pressure of 40 PSI are used. Commercial systems are available with large tanks being mounted onto the pressure washer and capable of operating several hoses simultaneously. For large fires, a pressure washer with several hoses with fine mist attachment would be necessary. The VMD for the pressure washer configuration was not measured but is expected to be very small for water and larger for PNS as PNS is more difficult to spray. PNS is polymeric and has much higher surface tension. Creating a fine mist of PNS requires higher pressure than water. PNS solution sprayed with a paint sprayer gives a fine mist but low volume due to ¼ inch input hose. A pressure washer can be obtained with large volume of spray and fine mist if the input line has a large diameter.

A fire truck projects water a long distance usually with a 2.5 inch hose and a very powerful pump. The fire truck becomes a pressure washer capable of creating a fine mist if a water wagon holding PNS solution is connected to the pump inlet and the 2.5 inch outlet with one or more hoses are configured with mist spray tips. Thus, pressure washer as used here is a very general term for a liquid pump that can create high pressure with an inlet hose for PNS solution that sprays out PNS mist. The total volume and pressure of fine mist could be large if counting several hoses. A fine mist does not project a long distance. A long wand (extends from 8 ft. to 20 ft.) can be easily attached to extend the distance reached by the mist. The wand is light weight as made from aluminum alloys and could be very long. Least expensive operation could be a pressure washer for each operator with a common tank for large fires. The systems including common tank could easily fit on a truck with cherry picker capability. A cherry picker is a hydraulic crane with a basket at the end for raising and lowering people. It is also known as boom lift, man lift, basket crane or hydra ladder. Often mounted on the back of a large vehicle (truck), cherry pickers can also be mounted on flat beds or paneled vans. Conventional fire trucks may be fitted with a cherry picker and converted to fine mist spraying as the fire trucks are already available. Spray systems are available to be installed on ATV (all terrain vehicle. A boon with multiple nozzles could be attached to the wand.

Experiments that Demonstrate that PNS Solutions can Extinguish Class A and B Fires Directly:

PNS was made according to claim 1 in U.S. Pat. No. 10,501,602 with PPA 115%. The method consisted of adding 9600 g PPA 115% to a reactor at 410° F. and then adding 4800 g DETA and mixing to form PNS (DETAPPA) with no emissions and no waste product. Another method consisted of adding and mixing together 480 g hydrophillic fumed silica (Aerosil 200) and 9600 g PPA 115% to a reactor at 410° F. Then 4800 g DETA was added and mixed to form PNS (DETAPA-FS) with no emissions and no waste product. EAPPA made by any method is part of this invention. Water was added and a solution by weight 45% PNS was made. Concentrations of 40-50% will be used for many of the following experiments. Initially, the sprayer with which the solution was applied to flames directly was a Graco paint sprayer PRO LTS 170 operated at maximum pressure of 3000 psi in order to obtain a very fine mist or fog. The spray rate for PNS solution is less than 0.25 gallon per minute and only projects three-four feet at most. The droplet size for a pressure of 3000 PSI should be about 20-70 microns if it were water. The droplet size could be larger for PNS as much higher viscosity than water. The aluminum pan for gasoline trials used initially was 1.75 inches deep, 10 inches wide, and 14 inches long. Fire is a result of vapors burning. Gasoline, a non polar solvent, emits vapors readily. Acetone, a polar solvent, emits vapors less readily.

Control spraying water: Eight oz. of gasoline grade 87 was placed in the pan. The thickness of the gas was consistent with a spill. The gas was set on fire. The Graco sprayer was placed about 4 feet from the pan. About 55 seconds was required for the fine mist water spray to extinguish the fire. Nearly all the fuel was consumed by the 55 seconds time and there was a lot of water in the pan. Water mist is known to have a cooling effect.
Experiment 1. Eight oz. of gasoline grade 87 was placed in the pan. The thickness of the gas was consistent with a spill. The gas was set on fire. The sprayer was placed about 4 feet from the pan. About 5-9 seconds was required for the fine mist spray to extinguish the fire. Most of the fuel was still in the pan. The DETAPA-FS solution mist sprayed into the flame almost immediately stopped the flame.
Experiment 2: Thirty two oz. (946 ml) of gasoline grade 87 was placed in the pan. The thickness of the gas was substantial. The gas was set on fire. The sprayer was placed about 6 feet from the pan. About 6-10 seconds was required for the fine mist spray to extinguish the fire as done multiple times. Most of the fuel was still in the pan. The DETAPA-FS solution mist almost immediately stopped the flame. A few more seconds were required to cool the fire. The pan was emptied into the quart jar and the solution was black from char formed from spraying the flames. About 7 oz. of fuel was consumed. About 4 oz. of DETAPPA solution accumulated at bottom of quart jar. It seems that the DETAPPA-FS mist dilutes and reacts with the gas vapor above the liquid gasoline almost immediately creating char so that the flaming is no longer possible. Without flaming, the gasoline cools and the fire quickly was extinguished. The pan was very cool to the touch. The smoke was quickly suppressed by the DETAPPA-FS mist.

The gasoline burned with a dark smoke. The darkness should be the result of particles or gasoline droplets within the smoke. These are highly flammable and are being lifted into the air and spread to nearby fuel and the likelihood of spreading the fire. The mist of DETAPPA-FS probably embeds within the smoke and reacts and converts to char. The DETAPPA-FS mist was likely burning off the vapors and droplets in the smoke and reducing the danger of the fire spreading. There is an initial burst of flame as the mist is sprayed onto the gasoline fire and then the flame goes out. At this point it would appear that the chain reaction of radicals and ions of a flame are being interrupted. These initial experiments were most surprising and initiated the concept that the chain reaction was being interrupted.

Comparative Experiment with Commercial Fire Extinguisher:

Thirty two oz. (946 ml) of gasoline grade 87 was placed in the pan. The thickness of the gas was substantial. The gas was set on fire. A Kidde 2× chemical fire extinguisher (purchased at Walmart) was applied to the fire for 30 seconds per instructions. The flames would die down but reignite once the spray was removed. The Kidde fire extinguisher emptied and the fire was still going and had spread on the ground near the sides of the pan. The paint sprayer was used to stop the fire with DETAPPA-FS taking about 15 seconds. Clearly, the DETAPPA-FS mist is much more effective with less DETAPPA-FS solution being used. The Kidde extinguisher failed despite using 4.5 lbs of chemicals on such a small fire. The chemical ingredients of the fire extinguisher are monoammonia phosphate, ammonium sulfate, mica, clay, and amorphous silica. There was a white and yellow powder remaining after application and a sulfur smell. The DETAPPA-FS solution was almost completely consumed by the flames and a small amount of DETAPPA-FS. A liquid was found at the bottom of the pan below the gasoline left in pan.

Experiment wood. The burst of flames associated with conversion of DETAPPA into char is easily visible with a brush fire. Half of a row of very dry branches randomly arranged two feet wide, 2 feet high, and 10 feet long was sprayed at one end with the mist of the paint sprayer. The uncoated side of the brush is ignited. The fire progresses rapidly until the sprayed area was reached. When the fire gets to the coated brush, a very visible burst of flame occurs and it appears to the observer that the DETAPPA coated brush was going to burn intensely. However, the flame consists of burst that quickly subsided leaving behind char coated brush and the fire stops at the interface region. The charred coated brush does not form embers or radiate heat onto surrounding brush. The flame, a chemical reaction, releases visible light that escaped without causing thermal heating of neighboring fuel. Uncoated brush that was ignited left behind embers that radiated heat for a long time. Coated brush that was ignited had a short lived burst of flame that cools nearly instantly and was inert to radiating heat. This effect is more difficult to observe for a flammable liquid.
Experiment 3: An identical experiment was performed with acetone, a polar solvent, four times. The acetone burns differently than gasoline. Acetone was more difficult to ignite and quickly boiled fiercely as compared to gasoline. The DETAPPA-FS mist stopped the flaming quickly, but spraying for extra few seconds was required to stop the fire from reigniting. The solution collected from the pan was about 14 oz. acetone and 14 oz. aqueous solution. Substantial char was observed in the aqueous solution.
Experiment 4: Dry wood sticks were ignited in a propane standard grill. The fire created substantial embers and was self sustaining. Application of the DETAPPA-FS mist with the paint sprayer stopped flaming. The spray had to be applied about three times until the embers cooled and could no longer ignite. Thus, a wood fire can be extinguished with a direct spray, but the DETAPPA-FS solution has to cool the embers to stop re ignition. The mist of DETAPPA-FS solution was quicker than the use of a water spray with far less liquid used.

In very large flammable liquid fires, it will be necessary to propel the fine mist DETAPPA solution further than 4 ft.

A solution containing by weight 70% DETAPPA and 30% water left standing will equilibrate to a lower molecular DETAPPA solution with no free water. For example, high molecular weight PPA 115% mixed with water releases heat and becomes a liquid with lower molecular weight. Same is expected for DETAPPA. Thereby a 70% solution does not really contain free water. The same concentration solution could be obtained by diluting the PPA 115% with water and then adding ethyleneamine. The solution could be obtained with a lower grade such as PPA 105%.

The two probes of an electrical meter were placed in a DETAPPA solution. The solution was conducting which supports the idea of DETAPPA mist readily forming ions in a hot flame. In an electrical fire it is important not to operate in water that is electrically active. As very little PNS solution is used, that should not be an issue.

These experiments support the idea that the flames containing volatile gas fumes react with the flame retardant mist. The reaction should result in some flaming with the wood and char and oxygen removal. This reaction should quickly drain the fire of heat, oxygen, and fuel. The concept that DETAPPA reacts with ions and radicals in a flame is reinforced.

The next examples are for very large gasoline fires extinguished with mist of DETAPPA-FS. The heat generated was very large and it was not possible for a comparative test to approach these fires to apply a dry chemical fire extinguisher at the base. A heavy protective suit would be required to work at the base. Re ignition also prevents dry chemical fire extinguishers from being the best choice for gasoline. Foam is usually sprayed from a far with high pressure spraying equipment.

In the next two examples, such large fires will be extinguished with DETAPPA-FS mist and a 4000 PSI pressure washer with fine mist flat tip nozzle and light weight aluminum wand that can extend to 21 ft. The wand contains a 0.25 inch hose within the aluminum wand. No special protective gear was needed for the operator. The wand even at 21 ft. extension is easily handled by one person. The fine mist nozzle is attached perpendicular to the wand so that when the wand is horizontal to the ground, the fan shaped spray pattern is directed downward or plunged into the fire. Initially the fan spray was directed into the fire to destroy the flames on the edge and suppress the heat. The tester can then move the fan onto the fire at a distance that a few seconds earlier was too hot. The largest flames were sprayed first and then shifted quickly to the sides back and forth.

Example 28.3 sq. ft. Gasoline Fire:

Two gallons of 40% concentration DETAPPA-FS solution was made. About 100 g of Tide laundry detergent (made by Proctor and Gamble, Cincinnati, Ohio) was added to the two gallons DETAPPA-FS solution and thoroughly mixed in. The soap has been found to partially compatibilize between the gasoline and DETAPPA-FS solution. The solution was put in a 2.5 gallon Amerex (Trussville, Ala.) 272 fire extinguisher and pressured to 100 PSI. The fire extinguisher was attached to a SIMPSON 4000 PSI GAS Pressure Washer (⅜ inch hose 50 feet long) with a 4 ft. garden hose. The variable length wand was fitted with an agriculture spray fitting from COUNTYLINE brass spray tip even flat spray ES 80-03 B (0.3 gallons water sprayed at 40 PSI) designed to create a flat mist at 80 degree width. With a 90° elbow ¼″ size, the spray tip is mounted perpendicular to the shaft so that the mist is directed downwards directly into the fire. The pressure washer that operates up to 4000 PSI creates a mist fan spray with the flat spray tip. The wand was extended only 4 feet. It was light weight and easily handled by one person. A burn experiment was then conducted using a 6 ft. in diameter metal tank (28.3 sq. ft.) with the depth being approximately 7 inches in depth. Two gallons of water and 2.5 gallons of octane 87 gasoline was placed in the tank and ignited. The black and deep red flames were shooting upwards at least 6 meters high and giving off a lot of heat. The heat was intense and the spraying had to be initiated a few feet away. But as the spraying started, the tester was able to walk up to the tank as heat quickly suppressed. The wand was used to spray mist created with the pressure washer directly or plunge onto the flames. It took 10 seconds to completely extinguish the fire. After 5 seconds of mist application, the fire is essentially out and no smoke. Pockets of re ignition occur which are quickly extinguished by applying the high pressure mist. Re ignition is the characteristic of gasoline fires that make them so difficult to extinguish with dry chemical extinguishers. A video of the fire shows that the thick black and red flames quickly turn white and then clear so that the trees on the other side of the fire become visible in less than two seconds. Less than two liters of solution was used to extinguish the fire. Slow motion also reveals the transition from dark flames to pink to white to clear as the fuel reacts with mist and took less than two seconds. The finer the mist the more quickly the reaction occurs and the least amount of DETAPPA-FS solution will be used. The gasoline remaining after the fire was black from char further supporting our understanding of the fire. Because the mechanism involves attacking the fuel in the flames, a mist of DETAPPA solution is applicable to all classes of fires regardless of size. Experimenting with a large 28 sq. ft. fire yields a much clearer picture of the mechanism that is operative.

Example 50 sq. ft. Gasoline Fire:

Two gallons of 50% concentration DETAPPA-FS solution was made. About 40 g of Tide laundry detergent was added to the two gallons DETAPPA-FS solution and thoroughly mixed in. A surfactant could have been substituted instead to lower the surface tension between the gasoline and the DETAPPA-FS solution. The soap has been found to partially compatibilize between the gasoline and DETAPPA-FS solution. The solution was put in a 2.5 gallon Amerex 272 fire extinguisher and pressured to 100 PSI. The fire extinguisher was attached to a SIMPSON 4000 PSI GAS Pressure Washer with a garden hose and an attachment that transitions form garden hose to pressure tank. The adjustable wand on the pressure washer was fitted with an agriculture spray fitting COUNTYLINE brass spray tip even flat spray ES 80-03 B specifically designed to create a mist directed downwards directly into the fire. With a 90° elbow ¾″ size, the spray tip is mounted perpendicular to the wand shaft so that the mist is directed downwards directly into the fire. The pressure washer that operates up to 4000 PSI creates a mist spray with the flat spray tip. A burn experiment was then conducted using a 8 ft. in diameter metal tank (50 sq. ft.) with the tank sides being approximately 6 inches in depth. Six gallons of water and 5 gallons of octane 87 gasoline was placed in the tank and allowed to settle. The gasoline was then ignited. The black and deep red flames were shooting upwards at least 8 meters high and giving off a lot of heat. Because of intense heat, the wand had to be extended to 11 ft. to initiate spraying mist created with the pressure washer directly into the flames. After two seconds, the tester can approach the tank and spray within. It took 19 seconds to completely extinguish the fire. After 8 seconds of mist application, the fire is essentially out. Pockets of reignition occur along the sides which are quickly extinguished by applying the high pressure mist. Re ignition is the characteristic of gasoline fires that make them so difficult to extinguish. A video of the fire showed that the thick black and red flames quickly turn white and then clear so that the trees on the other side of the fire became visible in less than four seconds. Immediately after, the spray rate was determined to be six liters per minute. About 2.2 liters of solution was used to extinguish the fire. Slow motion also reveals the transition from dark flames to pink to white to clear as the fuel reacts with mist took less than four seconds. From cone calorimeter data for DETAPPA coated wood, it is known that this reaction creates char and the heat produced in the reaction is reduced by 67% or so compared to uncoated wood. A larger reduction is expected for burning flammable liquids subjected to DETAPPA-FS mist. The finer the mist the more quickly the reaction occurs and the least amount of DETAPPA-FS solution is used. The gasoline remaining after the fire was black from char further supporting our understanding of the fire. Because the mechanism involves attacking the fuel in the flames, a mist of DETAPPA-FS solution is expected to be applicable to all classes of fires regardless of size.

There are different types of spray nozzles. Flat-fan nozzles are widely used for broadcast spraying of herbicides. These nozzles produce a tapered-edge, flat fan spray pattern. Most companies identify their flat-fan nozzles with a four or five digit number. The first numbers are the spray angle and the other numbers signify the discharge rate for water at rated pressure. The discharge rate is probably less for solutions as viscosity is usually higher. For example, an 8005 has an 80 degree spray angle and will apply 0.5 gallons per minute (GPM) at rated pressure of 40 psi which is suitable if spraying the surface of plants. ES 80-03 used above would have a 80 degree pattern and a rate of 0.3 GPM 40 PSI for spraying water. The rate and angle are less when spraying EAPPA solutions. The pressure washer at 4000 PSI provide a spray rate of about 6 liters per minute for the Countryline ES 80-03. Flat-spray tips are commonly available in 65°, 73°, 80° and 110° spray angles. Wider-angle flat tip nozzles produce smaller droplets, but they can be spaced farther apart on the spray boom or operated closer to the target. Narrow-angle spray tips produce a more penetrating spray and are less susceptible to clogging. The flat fan spray nozzle is preferred as covers more area. The flat fan spray is more suitable to cover the spray area of the flames. The most preferred is angle pattern of about 80°. Pressure much more than 40 PSI is necessary to penetrate the flames of large fires that are emitting a powerful pressure of flammable gases and combustion gases. As the pressure increases, the VMD drops and the rate in GPM were found to increase which is desirable. Pressure is necessary so that the fine mist is injected into the flames and onto and into the surface of the flaming liquid. A mist does not travel far as it disperses quickly with distance.

Example brush fire: A solution containing by weight 60% water and 40% DETAPPA-FS was formed. A large pile of dry brush about 6 ft. in height and 6 ft in diameter was constructed. A pan with three quarts of gasoline was placed under the edge of the brush on one side and ignited. Once the gasoline had burned, the large brush fire was sustainable and roaring at least 8 ft. high. The pressure washer with flat spray tip from previous examples was applied directly to the flames. The heat output was noticeably less than the gasoline fires so that the tester could approach within 4 feet of the fire and initiate spraying DETAPPA-FS solution without the long wand. The DETAPPA-FS solution applied directly to the flames extinguished the flames easily. There was a small re ignition which required two short bursts of spray. The back of the fire required small treatment as well. The class A fire was extinguished directly easily instead of spraying the fuel in front of the fire as stated in previous experiment wood example and in patent references. The wood sticks burned in earlier experiment wood were harder to extinguish because the sticks had all turned to embers.

A small utility house was constructed of plywood and 2 by 4 lumber. The house was approximately 2.5 ft wide, 4 ft long, 5 ft high with a one foot high roof. The house had a door that was left about 6 inches ajar. The house was surrounded by brush on all sides. The brush was ignited on the front of the house which after about 10 minutes had about one half of the house in flames. Using the 4000 psi pressure washer with flat tip spray nozzle, the flames were then sprayed with a 40% by weight solution of DETAPPA. The flames are completely and quickly knocked down. But the embers then start a fire again. After 5 cycles of this, the fire remained out even though the substantial amount of embers continued to smolder turning into small flames occasionally that self extinguished. Both DETAPPA and DETAPPA-FS seemed suitable for class A wood fires.

This identical experiment was repeated on brush and the small utility house. The 4000 PSI pressure washer was replaced with a Stihl SR 450 backpack mist sprayer for agricultural use that is very flexible in its use. The brush and house were ignited as before. However, the Stihl SR 450 was completely ineffective. The Stihl could not spray the DETAPPA solution as a fine mist approaching that done with a pressure washer. The fire was then extinguished with the pressure washer/flat tip sprayer. The Stihl sprayer is also ineffective on a 3 sq. ft. gasoline fire.

It should be noted that DETAPPA has a lower viscosity as measured with a Zahn cup method than DETAPPA-FS. As the viscosity goes up, it becomes more difficult to obtain a fine mist and requires higher pressure. Thickness also increases as viscosity goes up. There have been numerous products added to water to make water adhere better to wood fuel subject to wildfires. These products have a likelihood of making our solutions more sticky as well.

Hydrophillic fumed silica (15.6 g) was added to 1000 g of an aqueous solution containing 40% DETAPPA. This approach allowed FS to be added to DETAPPA solution as an upgrade. This sample was used to coat a 12 inch dowel with a paint brush. The coated dowel was still sticky after 3 days and displayed intumescent char when a propane torch was applied and behaved similar to DETAPPA-FS. Thus, addition of fumed silica to DETAPPA solution results in increased adhesion or stickiness and drip suppression so that a thicker coating obtained when applied to a fuel such as wood or to inflammable materials near the fire. But clearly for wood fires, solutions of DETAPPA-FS and DETAPPA with added fumed silica solutions had distinct advantages over DETAPPA solutions. However, the addition of FS increased the viscosity making the formation of mist to require extra pressure. The FS also stops the DETAPPA-FS solution being absorbed into the dry wood as compared to the ease that EAPPA with no FS absorbs into dry wood.

The DETAPPA and DETAPPA-FS solutions had a pH of about 3.5. DETA was added to the DETAPPA-FS solution to increase the pH to 4.3 and 4.7. Dowels coated with these two solutions were subjected to the propane torch as before. The amount of visible light released and the amount of intumescent char formed was found to go up as the pH goes up. It is very clear that raising pH increased the protective intumescent which should improve fire performance. The extra DETA is responsible for the extra char. It appears that this will be desirable for fighting any class of fire.

This is the first time DETAPPA and DETAPPA-FS solution have been used in the form of a fine mist directly applied into flames to extinguish fires and the examples being class A and B fires. The high pressure allows injecting into the flames and then to the base of the fire once the heat subsides and one can spray directly onto the fire. In previous patent reference U.S. Pat. No. 10,501,602, the application of a mist was unknown and the application directly to a flame was unknown and stopping the chain reaction was unknown. The usefulness of incorporating hydrophillic FS into ethyleneamine polyphosphate solutions was also unknown U.S. Pat. No. 10,501,602. High pressure is required to inject into the flames, enable cooling by the fast flowing mist, and a substantial volume of mist to be injected into the flames. For large fires, an extension on the mist wand is necessary as mist does not travel far and spreads quickly with distance. It is also useful to attach a boon containing to or nozzles to spray a larger pattern and suppress re-ignition.

The suppression of the 28 sq. ft. and 50 sq. ft. fires demonstrates that applying a fine mist of DETAPPA-FS solution results in suppression of flame, suppression of smoke, and suppression of heat very quickly. The DETAPPA-FS mist causes such suppression in any type of fire. The suppression is thought to result from the reaction of fine DETAPPA-FS mist with the ions and radicals that form the chain reaction of a fire. Pressure and power washers can be purchased that support several hoses simultaneously at 4000 PSI. Larger fires could be suppressed by utilizing several hoses applied by different operators and powered by pumps on current fire trucks. Alternatively, larger fires could be suppressed by utilizing several pressure washers with a common tank applied by different operators. The Amerex 272 fire extinguisher is advertised as a mist sprayer operating at a pressure of 100 PSI. However, the DETAPPA solution mist obtained with an Amerex 272 was found to be to coarse to extinguish an 8 sq. ft. gasoline fire. A Still SR 450 mist sprayer for agriculture also did not provide a mist that was suitable for 8 sq. ft. gasoline fires.

A working hypothesis has been proposed that DETAPPA or DETAPPA-FS mist reacts with the flames in fire to extinguish it by reacting with ions and free radicals and suppressing generation of heat. Such a working hypothesis has been useful. A lot of char has been observed and very little DETAPPA or DETAPPA-FS deposited in the test pan supports this interpretation of a reaction with the fuel. The invention does not rest on this interpretation or hypothesis and is operative regardless. This technology of spraying directly into the flames knocks down the flames that generate the heat. Once the generation of heat is arrested, it is much easier to cool the fuel to stop the emission of vapors that burn and keep the fire contained. This general principle has been observed for class A and B fires and is expected to be operative to all fires.

The prior art consists of U.S. Pat. No. 10,501,602. This prior art makes several references to spraying DETAPPA onto oil or in front of the fire. The spray has not been defined and the term mist has not been used in the specification of U.S. Pat. No. 10,501,602. On pg 4 line 30 of U.S. Pat. No. 10,501,602, it is stated that powdered forms of EAPPA and condensed EAPPA can be sprayed directly onto fires with a fire extinguisher instead of using mono-ammonium phosphate as the active ingredient In U.S. Pat. No. 10,501,602, the terms mist and agricultural spraying were not mentioned. On Pg 36 line 11, it is stated that “For gas fires, oil fires, chemical fires, tankers, airplanes, trains, and other contained fires, it is preferred to spray a powdered form of EAPPA directly onto the fire.”

It was stated (pg 21, line 13-15) that Oil and gas fires must be cooled and air starved as the only option and that EAPPA is unlikely to become part of a chemical reaction that adds to combustion. Such a statement is completely at odds with the interpretation of current work where the PNS solution is plunged into the flames and reacts with the flame directly. Looking at all these spraying references together, a method was not defined. It was not realized in this reference that a very efficient method to stop a class A or class B is by spraying a very fine mist into the fire or equipment to accomplish a fine mist is as easy as using an inexpensive pressure washer with a fine mist spray tip. Here, it was found very beneficial to use a pressure washer at 4000 PSI that delivers a fine mist and the high pressure projects the mist easily into the flames of the fire causing these flames to disappear. The high pressure prevents drift which is a big problem if spraying at 60 PSI. Agricultural spraying is done at about 60 PSI, and the fine mist is not projected very far and drift is a problem. The volume per minute sprayed is low as compared to our 4000 PSI pressure washer setup. In principle, a low pressure system should work especially if there are enough boons with nozzles spraying to stop the chain reaction and the spray boons were extended into the flames and over the width of the flames. The spray volume has to be such that the rate of reaction with the ions and radicals exceeds the rate of production of these. It appeared that six liters per minute spray rate is more than adequate for 28 sq. ft. but barely adequate for 50 sq. ft. gasoline fire.

It was also unexpected that a wood fire could be attacked directly by spraying a fine mist directly into wood flames which interrupts the chain reaction driving the fire. The direct application of PNS mist to flames would be especially useful in house fires. For non wood fires, it was stated in U.S. Pat. No. 10,501,602 that the preferred method is to use a powdered form of EAPPA or EAPPA concentrations exceeding 80% both of which are difficult to spray in fine mist form. The extreme moisture sensitivity of powdered forms of EAPPA makes such application very difficult. Here, it is disclosed that 40%-50% solutions of PNS applied in fine mist form using a pressure washer at 4000 PSI interact with ions and radicals in the flame to form char and stop non wood fires. The char is readily observed in the left over flammable liquid that did not burn. The approach is so efficient that gasoline fires of 28 Sq. ft. and 50 sq. ft. surface area were extinguished with only a small amount of PNS used.

It is preferred that the PNS mist be composed of droplets with VMD less than 1500 micron, or less than 600 microns preferred, or less than 400 microns more preferred, or less than 200 microns even more preferred, or less than 75 microns most preferred. Droplet size of 1500 microns is large but travels further with less wind drift as would be needed in large fires where heat emission does not allow close approach. A fan pattern of such droplets could be used on large fires where the droplets will explode into smaller droplets by the intense heat. It is preferred that the mist be sprayed in fan shape with flat tip spray nozzle which covers a larger area as the fan of mist is moved over the fire. Mist is applied with a pressure washer to which is connected a hose with a wand that contains one or more spray tips in the form of a boon for large fires.

For the application of the mist technology, measurement of droplet size is difficult and differs as the liquid changes. It is more practical to define the pressure and spray tip that was found to work well for most class A and B fires. There are thousands of agriculture spray nozzles from which to choose. The flat tip is preferred but other designs besides flat tip should work depending on the fire shape and size. Mist nozzles currently designed for spraying water from fire trucks should be applicable especially with modification for these fire fighting solutions. The agriculture nozzles are all sized for spraying water at 40 PSI which is adopted here for all nozzles even though the spray rate will be different for the more viscous PNS FR solutions using much higher pressures. It is preferred that each nozzle spray water at 40 PSI at a rate at least 0.05 GPM and less than 1.0 GPM. It is more preferred that the rate be at least 0.1 GPM and less than 0.6 GPM. The most preferred is 0.1 GPM to 0.3 GPM. The preferred spray angle is at least 60° and less than 120°. The more preferred is at least 80° and less than 110°. It is useful to construct a boon using very small nozzles such as the 0.1 GPM. With such spray tips, it is preferred that the pressure be at least 100 PSI, at least 400 PSI preferred, at least 800 PSI little more preferred, a pressure of 1500 PSI is more preferred, and at least 3000 PSI is most preferred. The pressure must be high enough to penetrate the flame from a fire and provide adequate volume of mist. The pressure must overcome gases from the fire and inject into the flame for the highest efficiency. Operation at 80-400 PSI maybe takes too long as the spray rate would be low, require more spray nozzles to stop the flames, and take longer time to extinguish possibly resulting in neighboring fuel catching on fire. It is preferred to utilize a pressure washer with agriculture very fine mist spray tip. For highly concentrated PNS solutions of greater than 60% concentration, it is preferred to use a power washer at a temperature of at least 50° F. to reduce the viscosity.

The volume and area of the fine mist spray needs to overcome the volume of vapors and emitted by the fire area. The surface area of the mist must also be a substantial portion of the fire and that waving the wand back and forth over the fire is easily accomplished. A fire truck modified as pressure washer seems a practical approach with a fire truck providing high pressure to multiple lines spraying a mist onto flames of any fuel type that greatly exceed 50 sq. ft. surface area. It is preferred that each line sprays a fan shaped mist with very fine droplet size and the fan patterns partially overlap. If a close enough approach is not possible, then the droplet size needs to exceed 1500 microns so that the droplets are propelled further by a given pressure. The droplets will break up by the air and also explode when plunged into the flames. A fan shaped spray of such coarse particles is preferred.

A fire sprinkler system is an active fire protection method, consisting of a water supply system, providing adequate pressure and flow rate to a water distribution piping system, onto which fire sprinklers are connected. In a standard wet-pipe sprinkler system, each sprinkler activates independently when the predetermined heat level is reached. Thus, only sprinklers near the fire will operate, normally just one or two. This maximizes water pressure over the point of fire origin, and minimizes water damage to the building.

The replacement of water in the sprinkler system with PNS solution would lead to more effective fire fighting. Sprinkler system using PNS solution would apply to much wider variety of fires. Fuel in a building can consist of all classes. The sprinklers should emit a mist with VMD of droplets being less than 600 microns or less than 400 microns preferred, or less than 200 microns more preferred, or less than 75 microns most preferred. Alternatively, the pressure in a mist sprinkler system should be at least 80-100 PSI, or at least 200 PSI preferred, or at least 800 PSI more preferred, or at least 2000 PSI most preferred.

Currently, a lot of water is used in sprinklers causing damage and the water dries quickly in a fire. Much less PNS solution would be needed and could be cleaned up readily with soap and water. The PNS solution does not dry out. It can dehydrate but remains effective, application to fuel near active flames prevents spreading.

An effective fire extinguisher containing the PNS aqueous solutions will spray mist if a) equipped with a fine mist nozzle and operated at a pressure so that the aqueous solution is discharged as a mist with VMD less than 1500 microns, or less than 600 micron preferred, or less than 400 micron more preferred, or less than 200 micron even more preferred, or less than 75 microns most preferred, or b) equipped with an aeration nozzle and operated at a pressure that discharges a foam with a specific gravity less than 0.55 g/ml preferred or less than 0.37 g/ml more preferred, or less than 0.25 g/ml most preferred. Measuring droplet size from a fire extinguisher is not very practical for fire departments or home owners. Another way is to define the fire extinguisher pressure. The pressure in a mist fire extinguisher should be at least 80-100 PSI, or at least 200 PSI preferred, or at least 800 PSI more preferred, or at least 2000 PSI most preferred.

For mist spraying, the preferred PNS solution concentration is greater than 3%, or greater than 10%, or greater than 45%, or greater than 65% by weight for PNS made with PPA 115%. The higher concentrations should ordinarily lead to quicker fire suppression and less volume of liquid to clean up afterwards.

PNS (EAPPA-FS is preferred) solutions offer an alternative to the use of fire fighting foam to extinguish flammable liquid fire even if the fire is a deep tank fire. Initially, the PNS droplets will react in the flames and become char that does not burn. The heat is quickly suppressed as the PNS mist is applied. A large endothermic effect accompanies char formation robbing the fire of heat. Thus, the flaming stops early. For a tank fire, re-ignition from hot metal walls requires extra time to treat and cool these edges. Such a method works for all fires provided that are enough nozzles to stifle re ignition.

### FF Foam Discussion and Data:

Teflon is inert to burning. The fluorosurfactants, such as fluorotelomers, perfluorooctanoic acid (PFOA), or perfluorooctanesulfonic acid (PFOS) are nearly inert to burning as these compounds consist almost entirely of Teflon like carbon fluorine bonds. The little burning of such fluorine compounds that occurs results in gaseous products not char as in the PNS method. The foam of fluorosurfactants and water are inert. PNS mist reacts with the fire to form char and rob it of heat by a highly endothermic reaction. PNS mist reacts with the flames. Foam is applied in a manner to form a barrier on top of the fuel. Here, this resistance to ignition will be called burn back resistance.

Teflon does not burn but it does conduct heat. Non stick cooking pans coated with Teflon work because the Teflon conducts heat. At very high temperatures, Teflon melts but does not convert to protective char such as occurs with EAPPA.

Fluorine free foams typically contain surfactants with organic constituents that burn in an intense fire. Here are some common examples of FF surfactants: Soaps (free fatty acid salts), Fatty acid sulfonates (the most common of which is sodium laryl sulfate, or SLS), Ethoxylated compounds, such as ethoxylated propylene glycol, Lecithin, Polygluconates, basically a glorified name for short-chain starches. The most widely used surfactants are thought to be sodium lauryl ether sulfate (SLES), ammonium lauryl sulfate, ammonium laureth sulfate, sodium myristyl sulfate and sodium myreth sulfate. Surfactants are compounds that lower the surface tension (or interfacial tension) between two liquids, between a gas and a liquid, or between a liquid and a solid. Surfactants may act as detergents, wetting agents, emulsifiers, foaming agents, and dispersants. Here, surfactants are compounds that lower the surface tension (or interfacial tension) between PNS solution and a flammable liquid such as gasoline.

An emulsifier keeps immiscible compounds from separating by increasing the kinetic stability of the mixture and has organic content subject to burning. Surfactants are one class of emulsifiers, which lower surface tension between liquids or between a solid and liquid.

Soap has defined as a water soluble compound made by a reaction (called saponification) between caustic soda (sodium hydroxide) or caustic potash (potassium hydroxide) with animal and/or vegetable fats (oils). Soap has surface active properties (see surfactant) to wet a greasy (oily) soiled surface and suspend the oil and dirt in the water for rinsing off. Synthetic soaps (called detergents) are made from petroleum-based products, and some heavy soaps (made from lead, zinc, or other heavy-metal compounds) are water-insoluble and are used mainly in lubricating greases. Surfactants are one of many different compounds that make up a detergent. Soaps were the earliest surfactants and are obtained from fats which are known as glycerides because they are esters formed by the trihydric alcohol, propane-1,2,3-triol (glycerol), with long chain carboxylic acids (fatty acids).

Organic solvents can be included to promote solubility of surfactants, to promote shelf life of the concentrate, and to stabilize the aqueous foam. Thickening agents can be used to increase viscosity and stability of the foam. Other agents and additives can be used as is known to those skilled in the art. Surfactants are included in the foaming compositions to facilitate foam formation upon aeration, to promote spreading of drainage from the foam composition as a vapor-sealing aqueous foam over a liquid chemical, and, where desired, to provide compatibility of the surfactant with sea water. Useful surfactants include water-soluble hydrocarbon surfactants and silicone surfactants, and may be non-ionic, anionic, cationic or amphoteric. Particularly useful surfactants include hydrocarbon surfactants which are anionic, amphoteric or cationic, e.g., anionic surfactants preferably having a carbon chain length containing from about 6 to about 12 or up to 20 carbon atoms. Saccharide surfactants, such as the non-ionic alkyl polyglycosides, can also be useful to the composition. Organic solvents can be included in the foaming composition to promote solubility of a surfactant, to improve shelf life of a concentrated adaptation of the foaming composition, to stabilize the foam, and in some cases to provide freeze protection. Organic solvents useful in the foaming composition include but are not limited to glycols and glycol ethers including diethylene glycol n-butyl ether, dipropylene glycol n-propyl ether, hexylene glycol, ethylene glycol, dipropylene glycol monobutyl ether, dipropylene glycol monomethyl ether, dipropylene glycol monopropyl ether, propylene glycol, glycerol, polyethylene glycol (PEG) and sorbitol.

Thickening agents are well known in the chemical and polymer arts, and include, inter alia, polyacrylamides, cellulosic resins and functionalised cellulosic resins, polyacrylic acids, polyethylene oxides and the like. One class of thickener that can be preferred for use in the foaming composition and methods of the invention is the class of water-soluble, polyhydroxy polymers, especially polysaccharides. The class of polysaccharides includes a number of water-soluble, organic polymers that can increase the thickness, viscosity or stability of a foam composition. Preferred polysaccharide thickeners include polysaccharides having at least 100 saccharide units or a number average molecular weight of at least 18,000. Specific examples of such preferred polysaccharides include xanthan gum, scleroglucan, heteropolysaccharide-7, locust bean gum, partially-hydrolyzed starch, guar gum and derivatives thereof. Examples of useful polysaccharides are described, for example, in U.S. Pat. Nos. 4,060,489 and 4,149,599. These thickening agents generally exist in the form of water-soluble solids, e.g., powders. While they are soluble in water, in their powder form they can and typically do contain a small amount of adventitious or innate water, which is absorbed or otherwise associated with the polysaccharide. Another thickener especially compatible with EAPPA is fumed silica.

All the ingredients used to make fluorine free (FF) foams contain organic constituents that will be consumed in intense fires and the bubbles with these compounds will collapse. Very different than foam made from fluorinated surfactants will not contribute to fire and will not readily collapse its foam bubbles. The addition of a flame retardant such as EAPPA will lend resistance to these organic constituents being consumed in a fire. EAPPA does not evaporate and turns to char from flames or intense heat. Thus, EAPPA solutions added to FF foam will add resistance to evaporation of water by providing some protection to the organic constituents of FF foam.

Smoke is the visible vapor and gases given off by a burning or smoldering substance, especially the gray, brown, or blackish mixture of gases and suspended carbon particles resulting from the combustion of wood, peat, coal, or other organic matter. Gasoline also gives off pungent black smoke when ignited. It will be observed that surfactants added to the flame retarding solutions of this invention appears to improve the fire extinguishing performance for class A and B fires by lowering the surface tension (or interfacial tension) between two liquids, between a gas and a liquid, or between a liquid and a solid.

Ethyleneamine sulfates such as ethylenediamine sulfate are listed as surfactants. There use is limited as there are toxicity issues with sulfates as compared to phosphates. Therefore, ethyleneamine sulfates are not the preferred surfactant or fire extinguishing agent even though such sulfates have excellent fire extinguishing properties.

Plunging is the direct application of flame retardant directly into the flames. Generally, for a flammable liquid fire, plunging not recommended as can splash the fire leading to spreading if using water, dry chemicals, carbon dioxide, or foam. Dry chemicals, carbon dioxide, and foam extinguishers are to be applied at the base of the flammable liquid fire. Foam should be sprayed as gently starting at the edge of the flammable liquid fire to form a continuous blanket starting. Water is not recommended for flammable liquid fires.

The surfactant SLES was found to aid in the mixing of EAPPA solutions and gasoline. Fifty g of DETAPPA 40% concentration solution was mixed with 1.2 g of SLES in ajar with lid. The two liquids did not separate even if left standing for several hours. Five g of gasoline was added and the ingredients were vigorously shaken. The gas did not separate out even after 60 minutes. The lid was removed and a torch was applied. The mixture did not catch on fire. This same experiment was repeated with 50 g DETAPPA 40% solution and 5 g of gasoline. The mixture separates into two solutions within 15 minutes. The lid was removed, a torch was applied and flaming occurs. Thus, it is apparent the SLES was successful in creating a new solution or emulsion probably consisting of tiny bubbles of gasoline embedded within the DETAPPA/SLES solution. Similar results were obtained with Tide laundry detergent from Proctor and Gamble. Thus, for gasoline fires, soap or SLES can be added to DETAPPA solutions for extinguishing flammable liquid fires.

In a blender was mixed 500 g water and 10 g of xanthan to form a 2% xanthan solution. In a jar was mixed 60 g of DETAPPS-FS 45% and 2.4 g of 2% xanthan solution followed by mixing 2.4 g of SLES. Next 20 g of gasoline was added and then sealed and shaken. The gas is completely emulsified within the solution. Application of a torch does not ignite this emulsified solution. Thus, a PNS-xanthan-SLES solution successfully emulsified a substantial amount of gasoline. This property should be quite useful in making FF foam from PNS-xanthan-SLES that suppresses gasoline fires.

Low expansion foams are effective in controlling and extinguishing most flammable liquid (Class “B”) fires. LOW EXPANSION FOAMs are aerated to an expansion ratio of between 2 to 1 and 20 to 1. MEDIUM EXPANSION FOAM have an Expansion ratio between 20 to 1 and 100 to 1. High-expansion foams are those that expand in ratios of over 100:1. Most high expansion foams have expansion ratios of from 400:1 to 1000:1. Creation of foam requires an air aspirator or addition compressed air to a stream of aqueous liquid (such as water mixed with a surfactant) flowing very rapidly through an aspirator to form foam. Such devises are often called Venturi pumps or educators and are specially constructed to create foam. An eductor is a device that uses the Venturi principle to introduce foam concentrate into the water stream. Water coming in the inlet of the eductor is directed through a tapered section and out through a small orifice (the Venturi) into a larger chamber thus creating a low pressure area within the chamber. A metering valve is attached to an inlet to this chamber and when open allows the higher atmospheric pressure outside the chamber to push the foam concentrate into the chamber. The foam concentrate then mixes with the water coming out the Venturi and the mixture travels out the reverse tapered section in the discharge end of the eductor. Compressed air foam (CAF) consists of adding compressed air to a solution of water and foam concentrate and then expelled from a hose at high volume.

A foam will be made consisting of PNS solution to which is added a surfactant. An even better foam requires both thickener and organic solvent. This solution will then be foamed with an eductor or aeration nozzle as commonly practiced with AFFF foam systems or a compressed air system (CAF). Such system will be applied to class A and class B fires. Such foam will then float on the surface of the fuel. An example will be shown where a gasoline fire is extinguished with PNS mist and then protected from re-ignition with a PNS based FF foam. Later, it will be shown that addition of a thickener such as xanthan gum improves the quality of the foam. The expansion ratio will be shown to further improve with addition of an organic solvent such as ethylene glycol butyl ether.

Fluorine free (FF) foam concentrates are complex mixture of chemicals. Thus, as a starting point it was preferable flame retard with PNS solutions a FF free foam such as Solberg RE-HEALING RF 3×6% ATC (Solberg ATC) sold by Perimeter Solutions, Clayton, Mo. U.S. Pat. No. 7,569,155 by Solberg provides a typical fluorine free (FF) foam concentrate as consisting of water 60-80%, Diethylene Glycol Monobutyl Ether 7-14%, starch (Butyl Di-Incinol), Xanthan Gum (Keltrol) 0-4%, Starch (Cerestar) 0-4%, Carbonised Sugar Blend Mix 3-20%, Diethanolamine Lauryl Sulfate 0-5%, Sodium Decyl Ethoxy Sulfate 0-5%, Cocamidopropyl Betaine Mix 0-5%, Cocamidopropyl Mix 0-5%, Hydroxy Sultaine Sodium Octyl Sulfate 0-5%, Sodium Decyl Sulfate 0-5%, and Alkyl polyglycocide 0-5% (C8-C16 distributions). The key ingredients are the solvents, thickening agents, water, and the surfactants. Instead of putting all these ingredients together, PNS solution at 40% to 65% concentration can be added to Solberg ATC, and as well as various amounts of surfactant, water, Diethylene Glycol Monobutyl Ether, and the thickening agent xanthan.

Example: DETAPPA 50% solution mixed with 3×6% ATC Foam concentrate (Solberg ATC): First, 50 g of 3×6% ATC Foam concentrate (Solberg ATC foam) was added to 50 g of DETAPPA aqueous solution of 50% concentration. Then 150 g water was added to the mixture. The sample was put in a quart glass jar and shaken for about 30 seconds. The jar completely filled with foam. The expansion was at least 6 fold. In a 200 ml glass jar was placed about 2 inches deep of gasoline octane 87. The foam was poured on top and found to float on top of the gasoline. After about 15 minutes, a torch was applied to the top of the foam and there was no ignition. Lack of ignition indicates that the gasoline below the foam is not emitting enough fumes to sustain flaming. An effort at ignition was made after 45 minutes and 120 minutes and still no ignition. At 120 minutes, the foam is collapsing so that the condensed foam has formed a layer below the gasoline. There is still adequate foam to protect the gasoline from emitting enough vapors to ignite by a torch. These results indicate that the SOLBERG ATC concentrate mixed with DETAPPA solution showed considerable protection from re-ignition which is referred as burn-back. The FF foam concentrate does contain organic solvents which is a negative from an environmental perspective.

Another sample of foamed DETAPPA with sodium lauryl ether sulfate (SLES) was made. DETAPPA 48% was made by dissolving 454 g DETAPPA in 500 g water. Fifty g of SLES was mixed with 50 g of DETAPPA 48% solution. The mixture was quite viscous. Next, 450 g of water was added and the mixture was mixed and aerated in a blender. In previous example, 150 g of water was used and shaken in a jar to aerate. The blender caused the mixture to foam with a ratio of about 9:1. In a small tapered glass jar 2 inch tall, 23 g of gasoline was added forming a ⅝ inch thick layer. A one inch layer of the just made foam was added. The foam rested on top of the gasoline. Small particles were observed falling through the gasoline layer and slowly collecting on the bottom. A torch was applied after ten minutes and thirty minutes and no flaming was observed. This foam was found to have the protective properties for flammable liquids. Foam made with SLES is preferred over Solberg ATC as there is no organic solvent and the performance was observed to be superior, although both worked. However, the expansion ratio is poor compared to Solberg ATC foam.

The military mil spec test (MIL-F-24385F) is performed on a fire consisting 10 gallons of gasoline in a 28 sq. ft. round tank and 15 gallons gasoline in 50 sq. ft. round tank. Ten gallons of gasoline added to a 28 sq. ft. tank will form a layer only 0.57 in thick. The US congress has mandated that a FF foam be made to replace the current fluorinated foams that pass this Mil SPEC test and is the target goal of this work.

The ingredients 500 g water, 50 g 48% DETAPPA, and 50 g SLES were added to a blender to form about 1.75 L of foam. Gasoline was added to a 14 in. by 9 in. metal pan to a depth of about ⅓ in. The foam was poured in from one edge. The foam quickly covered the entire pan. The depth of foam was about 2 in. A torch was applied over the surface at 3 minutes, 5 minutes, 10 minutes, 15 minutes, and 30 minutes with no ignition. It is apparent that the foam thickness was diminishing as the foam is slowly sinking below the gasoline. At 45 minutes, application of the torch resulted in a large flame as there was no longer a continuous foam covering. A large piece of cardboard was used to smother the flame. The contents were poured into a jar. The gasoline formed a layer on top of solution that is no longer foamed. This experiment was performed substituting Solberg ATC for SLES. The results were similar except that the foam made with Solberg ATC lasted longer and protected the gasoline longer.

In the next example, 500 g water, 25 g 48% DETAPPA, and 25 g Solberg ATC were added to a blender to form about 2 L of foam. To a tapered jar was added 25 g of gasoline and then 25 g of the just prepared foam. The foam has a density of approximately 0.25 g/ml, about ¼ the density of water and floated on the gasoline. A flame was applied at 60 minutes with no ignition. The foam settles to the bottom of the jar much more slowly than previous examples. The foam was applied to a 9×14 inch pan with burning gasoline and the flames quickly went out. The same foam was prepared with SLES substituted for Solberg ATC. The gasoline below the foam starts to burn at 30 minutes. The foam made with DETAPPA and Solberg ATC had better performance.

Foam containing PNS solution was found to have burn back capability. Thus, a new method of treating flammable liquid fires is to extinguish the flammable liquid fire with a mist of PNS solution and then apply foam containing PNS solution afterwards to provide burn back resistance. Such a method ties together the advantages of a fine mist with the advantages of fluorine free foam.

Example FF Foam Made with SLES

First, 50 g of SLES was added to 50 g of DETAPPA-FS aqueous solution of 50% concentration. The mixture is very viscous. Then 150 g water was added to the mixture. The sample was put in a quart glass jar and shaken for about 30 seconds. The expansion was about 2.5 times as measured by volume. The jar did not fill with foam. In a 200 ml standard kitchen measuring cup was placed about 50 ml of gasoline. The SLES/DETAPPA-FS foam was added to the 200 ml level. As this foam is heavier than that made with SOLBERG ATC, some falls through the gasoline. At 13 minutes and 36 minutes a torch was applied to the top of the foam and ignition did not occur indicating substantial burn back resistance.

In the foam examples using PNS solution, a common observation is that the foam drops through the gasoline with time and eventually there is no foam layer on top. The blanket of foam forms holes as time goes on allowing the gasoline to evaporate and pose a re-ignition hazard. It was found that the quality of the foam can be improved with a thickener used in a variety of products: paint, food, etc. A thickening agent or thickener is a substance which can increase the viscosity of a liquid without substantially changing its other properties.

Our examples are limited to food thickeners due to effort for health safety. Food thickeners frequently are based on either polysaccharides (starches, vegetable gums, and pectin), or proteins. A flavorless powdered starch used for this purpose is a fecula (from the Latin faecula, diminutive of faex, “dregs”). This category includes starches as arrowroot, cornstarch, katakuri starch, potato starch, sago, wheat flour, almond flour, tapioca and their starch derivatives. Microbial and Vegetable gums used as food thickeners include alginin, guar gum, locust bean gum, and xanthan gum. Proteins used as food thickeners include collagen, egg whites, and gelatin. Sugar polymers include agar, carboxymethyl cellulose, pectin and carrageenan. Other thickening agents act on the proteins already present in a food. One example is sodium pyrophosphate, which acts on casein in milk during the preparation of instant pudding.

Xanthan Gum is a microbial polysaccharide made from fermenting sugar with a bacteria called Xanthomonas campestris, which creates a gel that is dried and milled into a powder. The neutral-tasting gum acts as a powerful thickening, emulsifying, and stabilizing agent.

First, 36 g of xanthan was added to 6000 g of warm water and mixed in a blender. Next 2.4 g of hydroscopic fumed silica was added in the blender. The viscosity was increased substantially. Next 300 g of DETAPPA-FS 48% solutions was mixed in thoroughly followed by 300 g of Solberg ATC. The stirring was gentle so as not to cause substantial foaming. About 1.25 gallons of this foam solution was added to an Amerex 250 fire extinguisher and pressurized to 100 PSI. A test spray indicated the foam had a density of about 0.4 g/ml. Also, the foam when placed over gasoline in a glass jar indicates the foam does not drop out through the gasoline. The thickener causes the foam blanket to hold together and resist breaking into pieces that drop down as observed earlier. For the test, 2 gallons of water and one gallon of gasoline was added to a 8 sq. ft. tank which was then ignited with a torch. The foam was applied to the surface of the fire. The foam spread over the tank, sealed the sides, and extinguished the fire in about 10 seconds. At 4 minutes and 11 minutes, application of a torch over the tank did not re-ignite the fire. Application of the torch to the foam layer after 18 hours still failed to ignite the gasoline that apparently remains below the foam blanket. Thus, the addition of a thickener to the foam recipe results in a blanket behavior with protection against heat transmission, a blanket with strength to hold together, and a blanket that resists evaporation of the gasoline through it. If a torch is applied to a two inch thick foam blanket, the surface below the foam does not get hot. The surface of the foam starts to form char as the water evaporates and the DETAPPA-FS converts to char with the aid of the hydroxyls associated with the thickener.

The next example is the same except the addition of 6 g of SLES: 36 g of xanthan was added to 6000 g of warm water and mixed in a blender. Next 2.4 g of hydroscopic fumed silica was added in the blender. The viscosity was increased substantially. Next 300 g of DETAPPA-FS 48% solutions was mixed in thoroughly followed by 300 g of Solberg ATC and 6 grams of SLES. This solution in an Amerex 250 fire extinguisher extinguished the 8 sq ft fire easily. The SLES appears to have added more strength to the foam is a little more preferred over that without it. Thus it is preferred to add both SLES and a thickener to foam compositions made with DETAPPA-FS solution and Solberg ATC.

A pressure washer can be used to create foam. Instead of a flat spray tip, a foam cannon is used. The Maxx Foam Cannon sold at Lowes enabled foam with specific gravity less than 0.5 g/ml. An even better choice to create foam with a power washer was the MTM Hydro PF22 Professional Foam Lance sold by Amazon.com. Professional car detailers wash cars with a pressure washer with a foam cannon. The foam cannon converts soapy water to a foam with which to wash cars. One of the most highly rated foam cannons is TORQ snow cannon EQP 321, which was used here and purchased from www.chemicalguys.com.

The exact composition of FF Solberg re-healing RF 3×6 ATC (Solberg ATC) is unknown. The ingredients disclosed by Amerex Fire in an safety data sheet (SDS) supplied with the sample of SOLBERG ATC is 5-15% diethylene glycol butyl ether which is a solvent with coupling properties, 1-5% sodium octyl sulfate which is an anionic surfactant, 1-10% cocamidopropyl betaine which is a surfactant, 1-5% ethylene glycol which is a solvent miscible with water, and 60-90% non hazardous ingredients such as water. A thickener is expected to be part of the composition of Solberg ATC. The current supplier of SOLBERG ATC foam concentrate, Perimeter Solutions, only discloses in a safety data sheet (SDS) the composition as being a proprietary mixture consisting of hydrocarbon surfactants, complex carbohydrates, inorganic salts, solvent and water

The concentrate composition of the present invention also may comprise a polysaccharide, preferably an anionic heteropolysaccharide having a high molecular weight. Commercially available polysaccharides useful in the invention include those sold under the trademarks, e.g., Kelzan™ and Keltrol™ (available from Kelco). The polymeric structure is not critical for the purposes of this invention. Only a small amount of polysaccharide is required to result in a noticeable change in properties.

Another effective foam treatment will be described. DETAPPA and water were dissolved together in a blender, 500 g DETAPPA and 500 g water. A DETAPPA 50 solution was formed with no foaming. If 500 g DETAPPA-FS and 500 g water are dissolved in a blender, DETAPPA-FS-FS 50 solution was formed that is expanded about 20% due to foaming. Thus, the fumed silica content in DETAPPA-FS-FS solution results in some foaming which takes at least two hours to disappear. This foaming property will be shown to make DETAPPA-FS 50% concentration solution preferred over DETAPPA 50% solution for foam and mist.

A 2% xanthan solution was formed in blender by mixing 10 g xanthan with 500 g water. Next, 50 g of the 2% xanthan solution was mixed with 50 g of 45% DETAPPA FS solution and a viscous solution was formed. The mixture formed a gel after allowing to stand for a few hours. A gel did not form if xanthan is blended directly into DETEPPA FS solutions. It is preferred than xanthan be added as 1%-2% solution to DETAPPA solutions for the synthesis of foam solutions.

Thickeners such as xanthan are common ingredients in FF foam concentrates. If xanthan solution of one percent concentration and PNS solutions are mixed together, there is a reaction resulting in a viscous material that does not separate. If xanthan solution of one percent concentration and Solberg ATC are mixed together, there is a reaction resulting in a viscous material that does not separate if left standing. If PNS solutions are mixed with Solberg ATC, then the components tend to separate if left standing. These properties are important to the quality of foam with PNS solutions.

The composition to use for foam was chosen after mixing various combinations in a blender. Thus, 95% water and 5% Solberg ATC was mixed in a blender, and the subsequent foam had a weight of 160 g per 800 ml. A composition of 90% water, 5% Solberg ATC, and 5% DETAPPA-FS 50 solution mixed in a blender had a weight of 170 g/800 ml. A composition of 90% water, 5% Solberg ATC, and 5% DETAPPA 50 solution mixed in a blender had a weight of 190 g/800 ml. It was concluded that solutions made with DETAPPA-FS resulted in lighter weight foam than with DETAPPA. The foam weight increased about 15% if 0.5% xanthan solution was added. If it was desired to increase the amount of time that foam will hang together, then xanthan has this property but with the negative factor of making such foam heavier.

To stop a gas fire, it was concluded that a light weight foam is preferred since gasoline is very volatile and its surface easily disturbed. Several gallons of foam solution was prepared at a concentration of 90% water, 5% Solberg ATC, and 5% DETAPPA-FS. This foam solution in a Amerex 250 foam extinguisher yielded a foam with a weight of 120 g/800 ml, nearly factor of seven expansion and much lighter than gasoline.

The solution consisting of 90% water, 5% Solberg ATC, and 5% DETAPPA-FS 50 solution mixed in a blender had a weight of 170 g/800 ml. This solution was placed in a pressure tank with a bladder and a pressure of 50 PSI. The tank feeds the pressure washer. The TORQ foam cannon was attached to the pressure washer wand. The foam comes out with a lot of force. So the foam Cannon was modified so that the foam goes through a fine stainless steel screen which yielded a mild stream. A test run yielded foam of 125 g/800 ml nearly identical to that with Amerex 250 extinguisher. Two gallons of gasoline was added to a 28 sq. ft. tank containing two inches of water and ignited. The flames were to intense to get close enough for the Amerex 250 foam extinguisher to be used. The 13 ft. extension was added so that the power washer wand extends about 13 ft. The application of the DETAPPA-FS/Solberg ATC foam was applied and after about 7 seconds, the huge flames were knocked down and the operator walked up to the fire to put the remaining flames which took an additional 20 seconds. The flickering may have gone out on its own. After one minute, a propane torch was applied to the tank. The foam protected the gasoline underneath from ignition with the torch even though the application of foam was only for 30 seconds. It is apparent that the foam reacted with the vapors leaving the surface of the flaming gasoline in order to tame the flames so quickly.

A foam composition containing about 20% DETAPPA-FS and not containing Solberg ATC can be made by mixing 2000 g DETAPPA-FS 50% solution, 400 g SLES, 100 g 1% xanthan water solution, 2000 g water, and 100 g ethylene glycol butyl ether. This foam composition forms at a concentration of about 268 g/800 ml when foamed in a blender. This foam has a 3× expansion which seemed worked well in extinguishing a 8 sq. ft. gasoline fire. The expansion is less than 2× if ethylene glycol butyl ether is not added.

It is apparent that the use of ethylene glycol butyl ether is useful in making foam with good expansion. The preferred composition is the use of both ethylene glycol butyl ether and Solberg ATC with DETAPPA-FS solution. For example, a composition composed of 2000 g H2O, 100 g Solberg ATC, 200 g DETAPPA-FS 50%, 50 ethylene glycol butyl ether, 10 g xanthan 1% solution, and 70 g SLES yielded a foam concentration of 163 g/800 ml in a blender. Such a composition yielded a concentration of 130 g/800 ml with the foam cannon. This foam worked well in extinguishing a 28.3 sq. ft. gasoline fire.

The next composition can be used either as a form or as a mist. First, 133 g 2% xanthan is mixed with 133 g 45% concentration DETAPPA-FS to form a more viscous solution. Then 133 g SLES was added and then 4000 g water. Lastly, 43 g ethylene glycol butyl ether was added. Five batches were added to a standard water pressure tank with a bladder and pressurized to 50 PSI. The pressure tank then served as the source for a Simpson 4000 PSI pressure washer. The pressure washer wand was fitted with a boon consisting of three 0.1 size TEEJET flat head nozzles, spaced 12 inches apart. To a 28 sq. ft. circular tank was added 5 gallons gas and ignited. It took approximately 20 seconds for the fire to be extinguished within the 30 seconds allowed in the MTh SPEC test. The boon was replaced with TORQ foam cannon which was used to spray the tank with foam for 60 seconds. After one minute and five minutes, a propane torch failed to ignite the gas under the foam. Thus, with 90 seconds of application, it was possible to extinguish the 28 sq. ft. gasoline fire with a mist and then foam the tank for burn back resistance within 90 seconds as required by the MIL SPEC test. The tank was refreshed with fresh gasoline and ignited. It took approximately 60 seconds for foam to extinguish the fire exceeding the allowed 30 seconds.

It should be noted that a 45% concentration DETAPPA-FS using a boon with 30.1 nozzles takes about 9-10 seconds to extinguish a 28 SQ. Ft. fire of 5 gallons of gasoline. The DETAPPA-FS did not contain SLES or soap thus indicating that such ingredients may not be necessary. Thus, the lower concentration foam composition with 3% DETAPPA-FS 45% was successful but took longer and provided burn back resistance.

It seems that gasoline fires can be extinguished with mist in shorter time but subject to reigniting. Fires put out with foam take longer but have more resistance to reigniting or burn back resistance. The easiest technique to prepare foam is simply to add EAPPA-FS solution to existing commercial FF foam compositions and thereby get into usage quickly to help contain the growing threat from fires.

Perimeter Solutions has disclosed a generic FF foam via safety data sheet (SDS), with such composition being a proprietary mixture consisting of hydrocarbon surfactants, complex carbohydrates, inorganic salts, solvent and water.

Amerex Fire discloses in a safety data sheet (SDS) for FF foam the generic composition is 5-15% diethylene glycol butyl ether which is a solvent with coupling properties, 1-5% sodium octyl sulfate which is an anionic surfactant, 1-10% cocamidopropyl betaine which is a surfactant, 1-5% ethylene glycol which is a solvent miscible with water, and 60-90% non hazardous ingredients such as water. A thickener can be part of the composition of a foaming composition as well as a class of water-soluble, polyhydroxy polymers, especially polysaccharides. National Foam, West Chester, Pa. discloses a generic composition in its SDS for FF foam concentrate Propylene Glycol Monobutyl Ether (3-7%), Sodium Decyl Sulfate (1-5%), Sodium Octyl Sulfate (1-5%), Sodium laureth sulfate (1-5%), Butanedioic acid, 2-sulfo-, C-isodecyl ester, disodium salt (0.5-1.5%), 1-Dodecanol (0.1-1.0%), 1-Tetradecanol (0.1-1.0%).

Another generic FF foam composition from the Solberg co. typically consists of water 60-80%, Diethylene Glycol Monobutyl Ether 7-14%, starch (Butyl Di-Incinol), Xanthan Gum (Keltrol) 0-4%, Starch (Cerestar) 0-4%, Carbonised Sugar Blend Mix 0-20%, Diethanolamine Lauryl Sulfate 0-5%, Sodium Decyl Ethoxy Sulfate 0-5%, Cocamidopropyl Betaine Mix 0-5%, Cocamidopropyl Mix 0-5%, Hydroxy Sultaine Sodium Octyl Sulfate 0-5%, Sodium Decyl Sulfate 0-5%, and Alkyl polyglycocide 0-5% (C8-C16 distributions). All of these FF foam concentrates are quite similar and are somewhat generic. Tests have also been run adding PNS at 3% to Nation Foam Universal Green 3%-3 with for the 28 sq. ft. gasoline fire with similar results.

The most practical approach is to add EAPPA-FS solutions to such generic FF foam composition which has been shown to improve the ability of these generic FF foams to extinguish fires, especially flammable liquid fires. There is little incentive to create another FF foam composition that would most likely be similar previously disclosed FF foam compositions. It is very important that the foam land softly on the gasoline so not to substantially disturb the burning liquid surface. Foam near the surface of burning gasoline has high surface area which reacts with the ions and radicals streaming off the surface and thereby quench the flame. Char is always observed in the tank after a test from such char formation. A person knowledgeable in FF foams could substitute other thickeners, surfactants, organic solvents but would still behave as the generic foam described above.

One convenient practice of this invention consists of adding together FF foam from any manufacturer and an aqueous solution of EAPPA or EAPPA-FS at any ratio as well as a organic solvent, surfactant, and thickening agent. It is preferred that the ingredients be balanced so that a foam with standard equipment have a specific gravity in g/ml be less than 0.55, more preferred be less than 0.37, and most preferred be less than 0.25. The weight of the EAPPA solution or EAPPA-FS solution in the final foam solution should be at least 2% and less than 15% by weight. More preferred is 3% to 8%. FF foam concentrates can be made in a variety of ways by different suppliers and mixtures with these FF free foams with EAPPA or EAPPA-FS solutions is claimed in this invention. All of the FF foams are expected to mix with EAPPA and EAPP-FS solutions.

Methods of mist and foam have been defined to extinguish fires of any class which consist of applying a mist or a foam to the flames as well as to the fuel and materials near the fire. In the interest of safety, it is almost always preferred to extinguish a fire as fast as possible to reduce the chance of spread. Application of a mist that douses the flames directly is usually faster than applying foam and waiting for a protective layer to form between flames and fuel.

For most situations, it is preferred to use a flat tip nozzle that produces a fan shaped mist. The fan shaped mist is waved into the flames and moved from side to side to interact with the flames. It is preferred than the mist be directed downward towards the fire surface and maintain a distance above the surface so than no splashing of liquid occurs. The amount of mist needs to be adequate to douse the flames and not have a re ignition of flames. The volume of mist and area covered needs to be such that the fuel on one side of the fire has not reignited before the fan shaped mist has reached the other side. If the amount of mist is inadequate, then extra mist per unit time can be obtained with a boon containing several flat tip nozzles and possibly a higher pressure pump. Hundreds of different nozzles are available for agriculture and directly applicable here.

Mist can be formed at low pressure but only low volume of mist will be made. A pressure of 2000 PSI or greater will result in much higher volume of mist able to attack the large volume of volatiles that a large fire emits. High pressure emission also causes the droplets to break into higher surface area droplets. At low pressure, multiple sprayer heads on a boon with larger diameter hose and spray nozzle obtain same effect.

Mist can made from solutions of EAPPA, EAPPA-D, EAPPA-C, EAPPA-CD. These compositions can additionally contain fumed silica added directly to these solutions. Spraying the mist directly is important in tank and structure fires where it is important to douse the flames and associated heat so that nearby fuel does not catch on fire. It is important to spray nearby surfaces both fuel and inflammable materials on both A and B fires. A coating of PNS on any surface converts into protective char when subjected to heat or flames which substantially protects that surface from getting hot and transmitting heat.

It is more preferred to use compositions that contain FS as such solutions are stickier and thicker when applied to materials near the flames. The coating over these materials when subjected to heat forms an intumescent char that insulates and protects substantially against temperature rise. Even coating the insides of a tank fire helps douse the flames from re-ignition of fumes at the sides. To increase the amount of protective char, it is preferred for the flame retardant solutions to have a pH of at least 3.5, or it is more preferred to have pH of at least 4.2, or it is most preferred to have a pH of at least 5.0.

These EAPPA solutions are fertilizers due to high nitrogen and phosphorous content. Aqueous DETAPPA solution 40% concentration was added to the soil surrounding 6 tomato plants. The plants with EAPPA solution 40% applied to the soil grew faster than those without. Grass that had been treated with a mist coating of DETAPPA grew faster than that without. Cleary, the high P,N content makes these compounds good fertilizers. The absence of ammonia gives EAPPA solutions the property of not causing leaf burn when applied directly to plants. Grass and tomato plants did not suffer defoliation or leaf burn. The EAPPA solutions are very stable to sunlight as compared to ammonium phosphate solutions resulting in longer life and slower release.

We claim:

1. An aqueous fire extinguishing solution consisting of one or more aqueous solutions selected from the group consisting of ethyleneamine polyphosphate solution (EAPPA); doped ethyleneamine polyphosphate solution (EAPPA-D); condensed ethyleneamine polyphosphate solution (EAPPA-C); doped condensed ethyleneamine polyphosphate solution (EAPPA-CD) a) in the form of a mist or b) in the form of a foam or a mist when the aqueous solution additionally contains two or more compounds chosen from the group consisting of surfactant, thickening agent, water, and organic solvent.

2. The aqueous fire extinguishing solution according to claim 1 a) wherein the mist consists of droplets with a volume median diameter (VIVID) less than 1500 micron, or less than 600 micron, or less than 400 micron, or less than 200 micron, or less than 75 microns and b) wherein the foam has a specific gravity less than 0.55 g/ml or less than 0.25 g/ml.

3. The fire extinguishing aqueous solution according to claim 1 or 2, wherein the ethyleneamine is selected from the group consisting of ethylenediamine (EDA), diethylenetriamine (DETA), piperazine (PIP), triethylenetetramine (TETA), tetraethylenepentamine (TEPA), and pentaethylenehexamine (PEHA), the dopant is hydrophilic fumed silica, and pH is at least 3.5, or at least 4.2, or at least 5.0.

4. The aqueous fire extinguishing solution according to claim 1 wherein the aqueous solution has a concentration greater than 3%, or greater than 10%, or greater than 45%, or greater than 65%.

5. The aqueous fire extinguishing solution according to claim 1 or 2 wherein a) the mist when applied to a fire has at least one of the properties chosen from the group consisting of suppression of flame, suppression of smoke, suppression of heat, reacts with the flame plasma to form char and gases and b) the foam when applied to a fire has at least one of the properties chosen from the group consisting of formation of a blanket between flames and fuel, suppresses fuel evaporation, enhances protection of fuel from ignition.

6. The aqueous fire extinguishing solution of claim 1 or 2 is replaced by an aqueous solution chosen from the group consisting of ammonium phosphate solution, ammonium polyphosphate solution, ethylenediamine sulfate solution, piperazine sulfate solution, and diethylenetriamine sulfate solution and the concentration by weight is of at least 3% or at least 20% and the solution may additionally contain pentaerythritol or dipentaerythritol.

7. A method using pressure to create a) the mist of claim 1 and claim 6 by forcing the aqueous fire extinguishing solution through a mist spray nozzle and b) the foam of claim 1 and claim 6 by forcing the solution through an aeration foam spray nozzle or a foam cannon.

8. The pressure in claim 7 is at least 100 pounds per square inch (PSI), or at least 400 PSI, or at least 800 PSI, or at least 1500 PSI, or at least 3000 PSI and the mist is created with a flat tip spray nozzle.

9. The equipment to create the mist of claim 7 or 8 are chosen from the group consisting of
1) airless spray gun pumping the aqueous fire extinguishing solution at a very high pressure, up to 7,000 psi, through a hose and out a tiny hole in the spray gun tip, with the tip designed to break up the solution evenly into a fan-shaped spray pattern of tiny droplets,
2) Air assisted airless spray gun that adds compressed air to an airless spray gun,
3) Air blast sprayer that injects aqueous fire extinguishing solution into a fast-moving stream of air which breaks down large droplets into smaller droplets,
4) Hydraulic atomization of aqueous fire extinguishing solution,
5) Low-volume sprayer with air pumped from an air compressor or turbine which atomizes aqueous fire extinguishing solution,
6) High volume low pressure (HVLP) air pumped from an air compressor or turbine atomizes aqueous fire extinguishing solution.
7) Pressure washer or power washer equipped with a mist nozzle.

10. A method to extinguish a fire by spraying a) the mist of claim 8 or 9 into the flames of a fire or b) the foam of claim 8 or 9 onto the fire so that the foam spreads a blanket over the fuel.

11. The method according to claim 10 has volume and pressure such that the a) mist penetrates the flames and reacts with the flames to suppress the flames or b) foam penetrates the flames and forms a blanket between the fuel and flames.

12. The method according to claims 10 and 11 wherein a) the mist has at least one of the properties chosen from the group consisting of suppression of flame, suppression of smoke, suppression of heat, reaction with the flame plasma to form char and gases and b) the foam has at least one of the properties chosen from the group consisting of formation of blanket for suppression of flame, suppression of vapor emission, and suppression of heat.

13. A method for stopping the spread of a fire consisting of a) spraying the mist of claims 1-5 or b) spraying the foam of claims 1-5 onto the flammable and inflammable materials in the vicinity of the fire.

14. A fire extinguisher containing the a) aqueous mist solution of claims 1-4 with said extinguisher equipped with a nozzle with mist spray tip and operated at a pressure so that the aqueous solution is discharged as a mist with VMD less than 1500 microns, or less than 600 micron, or less than 400 micron, or less than 200 micron, or less than 75 microns, and b) aqueous foam solution of claims 1-4 with said extinguisher equipped with an aeration nozzle and operated at a pressure that discharges a foam with a specific gravity less than 0.55 g/ml or less than 0.37 g/ml, or less than 0.25 g/ml.

15. The pressure in claim 14 is at least 80-100 PSI, or at least 200 PSI, or at least 800 PSI, or at least 2000 PSI.

16. A fire extinguishing system composed of a pressurized tank containing the aqueous solutions of claims 1-6 that a) operates with a flat tip spray nozzle at a pressure and flow rate such that a mist is discharged with a VMD less than 1500 microns, or less than 600 micron, or less than 400 micron, or less than 200 micron, or less than 75 micron or b) operates with a foam cannon at a pressure and flow rate that a foam with specific gravity less than 0.55 g/ml or less than 0.25 g/ml is discharged.

17. The mist in claim 16 is delivered by a system consisting of at least one boon with at least two nozzles where the boon is projected into the flames and that the system operates at a pressure that discharges a mist with VMD less than 1500 microns, or less than 600 micron, or less than 400 micron, or less than 200 micron, or less than 75 micron.

18. A sprinkler system with the aqueous solution of claims 1-4 being the fluid in the system and that the pressure and the sprinkler heads are such that the VMD of the emitted mist has a VMD less than 1500 microns, or less than 600 micron, or less than 400 micron, or less than 200 micron, or less than 75 micron.

19. The foam of claim 1 contains one or more organic solvents chosen from the group consisting of diethylene glycol n-butyl ether, dipropylene glycol n-propyl ether, hexylene glycol, ethylene glycol, dipropylene glycol monobutyl ether, dipropylene glycol monomethyl ether, dipropylene glycol monopropyl ether, propylene glycol, glycerol, polyethylene glycol (PEG), sorbitol; one or more thickeners chosen from the group consisting of xanthan gum, scleroglucan, heteropolysaccharide-7, locust bean gum, partially-hydrolyzed starch, guar gum; one or more surfactants chosen from the group consisting of sodium lauryl ether sulfate (SLES), ammonium lauryl sulfate, ammonium laureth sulfate, sodium myristyl sulfate and sodium myreth sulfate.

20. A fluorine free (FF) foam consisting of a mixture of a generic foam composition and the aqueous foam solution of claim 1 at any ratio.

21. The aqueous fire extinguishing solutions of claim 1 in the form of a mist for use as a fertilizer applied directly to plants or to soil.
